(19) United States
(12) Patent Application Publication
(10) Pub. No.: US 2024/0004322 A1
(43) Pub. Date: Jan. 4, 2024

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: KOHEI MAKISUMI, Shizuoka (JP); SHUNTARO WATANABE, Kanagawa (JP); TAICHI SATO, Shizuoka (JP); TOMOHITO ISHIDA, Shizuoka (JP); MASATADA HIROTA, Shizuoka (JP); TSUTOMU NISHIDA, Shizuoka (JP)

(21) Appl. No.: 18/340,228

(22) Filed: Jun. 23, 2023

(30) Foreign Application Priority Data
Jul. 4, 2022 (JP) 2022-107921
Mar. 9, 2023 (JP) 2023-036758
Apr. 26, 2023 (JP) 2023-072660

(51) Int. Cl. G03G 5/087; G03G 21/18

(52) U.S. Cl. CPC G03G 5/087; G03G 21/1814

(57) ABSTRACT

The electrophotographic photosensitive member includes a surface layer containing a binder resin, electroconductive particles, and insulating particles, wherein when a volume resistivity of the insulating particles is represented by R1 [Ω·cm], a volume resistivity of the electroconductive particles is represented by R2 [Ω·cm], a ratio of an area of the insulating particles that are exposed to a total area of the surface layer is represented by S1 [%], a ratio of an area of the electroconductive particles that are exposed to the total area of the surface layer is represented by S2 [%], an average exposed height of the insulating particles exposed to a surface of the electrophotographic photosensitive member is represented by L1 [nm], and an average exposed height of the electroconductive particles exposed to the surface of the electrophotographic photosensitive member is represented by L2 [nm], those parameters satisfy specific relational formulae.

### BACKGROUND OF THE INVENTION

### Field of the Invention

The present invention relates to an electrophotographic photosensitive member, and a process cartridge and an electrophotographic apparatus each including the electrophotographic photosensitive member.

### Description of the Related Art

As an electrophotographic photosensitive member (hereinafter also referred to as “photosensitive member”) to be mounted onto an electrophotographic apparatus, there is widely used an electrophotographic photosensitive member containing an organic photoconductive material serving as a charge-generating material. In recent years, an improvement in mechanical durability, that is, abrasion resistance of the electrophotographic photosensitive member has been required for the purposes of lengthening a lifetime of the electrophotographic photosensitive member and improving image quality at the time of its repeated use.

Meanwhile, when image printing is repeated, a discharge product is produced by discharge occurring between the photosensitive member and a charging member at the time of a charging step, and remains on the surface of the electrophotographic photosensitive member. The discharge product absorbs moisture in air to reduce the resistance of the surface of the photosensitive member, and hence charge formed on the photosensitive member moves on the outermost surface thereof. Accordingly, a desired electrostatic latent image may blur to cause a phenomenon called endurance image smearing on an image output on paper or the like.

An approach to alleviating the endurance image smearing is, for example, an approach to improving the injection chargeability of the photosensitive member in which the charge is loaded on the surface of the photosensitive member not by the discharge but by charge injection in the charging step. When most of the charging is achieved not by the discharge but by the injection, the amount of the discharge product to be produced at the time of the discharge is suppressed, and hence the endurance image smearing can be reduced. An example of the approach to improving the injection chargeability is as follows: electroconductive particles are incorporated into the surface layer of the photosensitive member to control the volume resistivity of the surface of the photosensitive member, and hence the injection chargeability can be improved. However, the control with the electroconductive particles remarkably reduces the resistance of the surface of the photosensitive member, and hence the charge moves in a film serving as the surface irrespective of the presence or absence of the discharge product to cause image smearing at the initial stage of the use of the photosensitive member (hereinafter referred to as “initial image smearing”).

Meanwhile, one of steps to be performed by the electrophotographic apparatus is a transferring step. In the step, efficient movement of toner with which a latent image on the surface of the photosensitive member has been developed to a medium, such as paper or an intermediate transfer member, without any waste is required. To transfer the toner with which the latent image on the photosensitive member has been developed onto the medium in the transferring step, a predetermined bias has been applied to the toner. The bias to be applied can be reduced as follows: an external additive is added to the toner to produce a shape on the surface of the photosensitive member, to thereby reduce the adhesive property of the toner to the surface of the photosensitive member. Thus, a space for a high-voltage power source for applying a high bias can be saved in the electrophotographic apparatus. Moreover, the scattering of the toner caused by a high transfer bias can be suppressed, and hence an improvement in image quality can be achieved. The following has heretofore been proposed as one method of reducing the adhesive force of the toner to the surface of the photosensitive member through the production of the shape on the surface of the photosensitive member: to bring the toner and the surface of the photosensitive member into point contact with each other, particles are incorporated into the surface of the electrophotographic photosensitive member to form convex shapes thereon.

In Japanese Patent Application Laid-Open No. 2009-229495, there is a description of a technology including incorporating electroconductive titanium oxide particles into the protection layer of a photosensitive member for maintaining a cleaning property and for maintaining a stable potential characteristic even under a severe environment.

In Japanese Patent Application Laid-Open No. 2020-071423, there is a description of a technology including controlling convex shapes on the surface of toner and incorporating an inorganic filler into the outermost layer of a photosensitive member for improving a cleaning property.

In Japanese Patent Application Laid-Open No. 2015-169871, there is a description of a technology including incorporating P-type semiconductor particles and insulating crosslinked resin particles into the protection layer of a photosensitive member for improving the abrasion resistance and image stability thereof.

In Japanese Patent Application Laid-Open No. 2013-195707, there is a description of a technology including causing electroconductive particles to be present near insulating particles in the protection layer of a photosensitive member for improving the abrasion resistance thereof and for suppressing an increase in potential of the exposure portion thereof.

In Japanese Patent Application Laid-Open No. 2014-002364, there is a description of a technology including incorporating tin oxide treated with a special surface treatment agent and silica particles into the protection layer of a photosensitive member for increasing the surface hardness of the protection layer to improve the abrasion resistance and flaw resistance thereof.

### SUMMARY OF THE INVENTION

However, an investigation made by the inventors of the present invention has found that in each of the electrophotographic photosensitive members described in Japanese Patent Application Laid-Open No. 2009-229495, Japanese Patent Application Laid-Open No. 2020-071423, Japanese Patent Application Laid-Open No. 2015-169871, Japanese Patent Application Laid-Open No. 2013-195707, and Japanese Patent Application Laid-Open No. 2014-002364, the following is not sufficiently achieved: the photosensitive member suppresses initial image smearing and has improved transferability while having improved injection chargeability.

Accordingly, an object of the present invention is to provide an electrophotographic photosensitive member, which suppresses initial image smearing and has improved transferability while having improved injection chargeability.

The above-mentioned object is achieved by the present invention described below. That is, the present invention is directed to an electrophotographic photosensitive member including a surface layer containing a binder resin, electroconductive particles, and insulating particles, wherein when a volume resistivity of the insulating particles is represented by R1 [Ω·cm], a volume resistivity of the electroconductive particles is represented by R2 [Ω·cm], a ratio of an area of the insulating particles that are exposed to a total area of the surface layer is represented by S1 [%], a ratio of an area of the electroconductive particles that are exposed to the total area of the surface layer is represented by S2 [%], an average exposed height of the insulating particles exposed to a surface of the electrophotographic photosensitive member is represented by L1 [nm], and an average exposed height of the electroconductive particles exposed to the surface of the electrophotographic photosensitive member is represented by L2 [nm], the R1, the R2, the S1, the S2, the L1, and the L2 satisfy the following formulae (1) to (7).

10¹⁰≤R1 (1)

R2≤10⁸ (2)

5≤S1≤75 (3)

25≤S1+S2≤95 (4)

0.13≤S1/S2≤3.8 (5)

30≤L1≤180 (6)

1.2≤L1/L2≤2.8 (7)

The present invention is also directed to a process cartridge including: the above-mentioned electrophotographic photosensitive member; and at least one unit selected from the group consisting of: a charging unit; a developing unit; and a cleaning unit, the process cartridge integrally supporting the electrophotographic photosensitive member and the at least one unit, and being detachably attachable onto a main body of an electrophotographic apparatus.

The present invention is also directed to an electrophotographic apparatus including: the above-mentioned electrophotographic photosensitive member; and a charging unit, an exposing unit, a developing unit, and a transfer unit.

According to the present invention, the electrophotographic photosensitive member, which suppresses initial image smearing and has improved transferability while having improved injection chargeability, can be provided.

Further features of the present invention will become apparent from the following description of exemplary embodiments with reference to the attached drawings.

### BRIEF DESCRIPTION OF THE DRAWINGS

FIG. 1 is an illustration of an example of the layer configuration of an electrophotographic photosensitive member according to the present invention.

FIG. 2 is a view for illustrating an example of the schematic configuration of an electrophotographic apparatus including a process cartridge including the electrophotographic photosensitive member and a charging unit.

FIG. 3 is a conceptual view obtained by observing the surface layer of the electrophotographic photosensitive member according to the present invention from above (surface observation).

FIG. 4 is a conceptual view obtained by observing the surface layer of the electrophotographic photosensitive member according to the present invention from the side (sectional observation).

FIG. 5 is a view based on an example of a STEM image (photograph) of electroconductive particles according to the present invention.

FIG. 6 is a view for schematically illustrating the STEM image of FIG. 5.

### DESCRIPTION OF THE EMBODIMENTS

The present invention is described in detail below by way of exemplary embodiments.

[Electrophotographic Photosensitive Member]

An electrophotographic photosensitive member of the present invention is characterized by including a surface layer.

The term “surface layer” as used herein refers to a layer positioned on the outermost surface in the photosensitive member, and means a layer to be brought into contact with a charging member or toner.

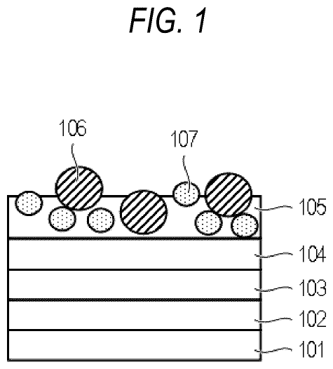

FIG. 1 is a view for illustrating an example of the layer configuration of the electrophotographic photosensitive member. In FIG. 1, a support is represented by reference symbol 101, an undercoat layer is represented by reference symbol 102, a charge-generating layer is represented by reference symbol 103, and a charge-transporting layer is represented by reference symbol 104. The surface layer according to the present invention is represented by reference symbol 105, insulating particles according to the present invention are each represented by reference symbol 106, and electroconductive particles according to the present invention are each represented by reference symbol 107.

As a method of producing the electrophotographic photosensitive member of the present invention, there is given a method involving preparing coating liquids for the respective layers to be described later, applying the coating liquids in a desired order of layers, and drying the coating liquids. In this case, examples of a method of applying the coating liquid include dip coating, spray coating, inkjet coating, roll coating, die coating, blade coating, curtain coating, wire bar coating, ring coating, and dispense coating. Of those, dip coating is preferred from the viewpoints of efficiency and productivity.

The respective layers are described below.

<Surface Layer>

According to an investigation made by the inventors of the present invention, the surface layer contains a binder resin, electroconductive particles, and insulating particles, and when the volume resistivity of the insulating particles is represented by R1 [Ω·cm], the volume resistivity of the electroconductive particles is represented by R2 [Ω·cm], the ratio of the area of the insulating particles that are exposed to the total area of the surface layer is represented by S1 [%], the ratio of the area of the electroconductive particles that are exposed to the total area of the surface layer is represented by S2 [%], the average exposed height of the insulating particles exposed to the surface of the electrophotographic photosensitive member is represented by L1 [nm], and the average exposed height of the electroconductive particles exposed to the surface of the electrophotographic photosensitive member is represented by L2 [nm], the R1, the R2, the S1, the S2, the L1, and the L2 need to satisfy the following formulae.

10¹⁰≤R1 (1)

R2≤10⁸ (2)

5≤S1≤75 (3)

25≤S1+S2≤95 (4)

0.13≤S1/S2≤3.8 (5)

30≤L1≤180 (6)

1.2≤L1/L2≤2.8 (7)

Although the reason why the effect of the present invention can be exhibited by the above-mentioned conditions has not been clearly elucidated, the inventors of the present invention have assumed the reason to be as described below.

As described above, one approach to improving the injection chargeability of the electrophotographic photosensitive member includes, for example, causing low-resistance electroconductive particles to be present in the surface layer of the photosensitive member to form starting points that promote injection charging. From the viewpoint, as represented by the formula (2), the volume resistivity R2 [Ω·cm] of the electroconductive particles needs to be 10⁸ or less.

In the present invention, the volume resistivity of particles is measured under a normal-temperature and normal-humidity environment (having a temperature of 23° C. and a relative humidity of 50%). In the present invention, a resistivity meter LORESTA GP manufactured by Mitsubishi Chemical Corporation was used as a measuring apparatus. The particles of the present invention to be subjected to the measurement were compacted at a pressure of 500 kg/cm² to provide a pellet-shaped sample for measurement, and an applied voltage was set to 100 V.

At this time, when the particle diameters of the electroconductive particles are excessively large, initial image smearing is liable to occur because an electroconductive path is formed by the electroconductive particles in a film serving as the surface layer. Accordingly, to achieve both of the injection chargeability and the suppression of the initial image smearing, the electroconductive particles cannot be made excessively large.

Meanwhile, to improve transferability in an electrophotographic image forming apparatus, the adhesive force of toner with which an electrostatic latent image on its photosensitive member is developed needs to be reduced. The adhesive force between the toner and the electrophotographic photosensitive member is roughly classified into an electrostatic adhesive force and a non-electrostatic adhesive force. The electrostatic adhesive force is mainly caused by an image force, and hence largely depends on the charge quantity of the toner. The magnitude of the image force is proportional to the charge quantity of the toner, and is inversely proportional to the square of a distance between the toner and the surface of the photosensitive member to which the toner is to adhere. Accordingly, as the heights of the particles exposed from the surface of the photosensitive member (hereinafter also referred to as “exposed heights”) become higher, the distance between the photosensitive member and the toner can be made longer. Accordingly, the image force becomes smaller, and hence the transferability is improved. An approach to increasing the exposed heights is, for example, an increase in size of each of the particles to be introduced or the push-up of the particles toward the upper portion of the film by an increase in ratio of the particles in the film. However, as described above, the electroconductive particles cannot be made excessively large from the viewpoint of suppressing the initial image smearing. Accordingly, the exposed heights need to be secured with the insulating particles that do not contribute to the suppression of the initial image smearing. That is, the following is required: the injection chargeability and the suppression of the initial image smearing are secured with the electroconductive particles, and the transferability is secured with the insulating particles. Further, the authors have made an investigation, and as a result, have found that when a plurality of particles having different particle diameters are caused to coexist in the surface layer, the control of the exposed heights of the particles is facilitated. The inventors have assumed that this is because of the following reason: the electroconductive particles having small particle diameters fill gaps between the insulating particles having large particle diameters to prevent the embedment of the particles at the time of the drying of a coat for forming the surface layer, and hence the heading of the particles is promoted. The ratio of the total sum of the volumes of the electroconductive particles and the insulating particles to the total volume of the surface layer is preferably 40% or more. Meanwhile, in the case where the average exposed height L1 [nm] of the insulating particles is excessively increased, the ratio “L1/L2” of the L1 to the average exposed height L2 [nm] of the electroconductive particles exposed to the surface of the photosensitive member increases. In this case, the electroconductive particles exposed to the surface of the photosensitive member cannot be brought into contact with a charging member, and hence the photosensitive member cannot exhibit sufficient injection chargeability. Accordingly, a certain limitation is placed on the size of the L1. As represented by the formula (1), the volume resistivity R1 [Ω·cm] of the insulating particles needs to be 10¹⁰ or more. In addition, the R1 is preferably 10¹³ or more as represented by the following formula.

10¹³≤R1 (8)

As represented by the formula (6), the average exposed height L1 [nm] of the insulating particles needs to be 30 or more and 180 or less. The ratio “L1/L2” of the average exposed height L1 [nm] of the insulating particles to the average exposed height L2 [nm] of the electroconductive particles needs to be 1.2 or more and 2.8 or less as represented by the formula (7), and is more preferably 1.5 or more and 2.5 or less.

In addition, when the amount of the particles exposed to the surface of the photosensitive member is small, a mutual distance between the exposed particles is large, and hence the toner and the surface of the photosensitive member are brought into direct contact with each other. Accordingly, the distance between the toner and the photosensitive member cannot be lengthened, and hence the transferability cannot be improved. Meanwhile, in the case where the ratio of the particles exposed to the surface of the photosensitive member is excessively large, the surface of the photosensitive member is completely filled with the particles to be brought into a state close to a flat surface. In this case, the distance between the toner and the photosensitive member may be close to a distance between the toner and each of the exposed particles. Accordingly, the image force becomes larger to deteriorate the transferability. Accordingly, when the ratio of the area of the insulating particles that are exposed to the total area of the surface layer and the ratio of the area of the electroconductive particles that are exposed to the total area are represented by S1 [%] and S2 [%], respectively, as represented by the formula (3), the S1 needs to be 5 or more and 75 or less. In addition, the sum (S1+S2) [%] of the S1 and the S2 needs to be 25 or more and 95 or less as represented by the formula (4), and a quotient (S1/S2) between the S1 and the S2 needs to be 0.13 or more and 3.8 or less as represented by the formula (5).

Further, the control of the particle diameters of the insulating particles can further improve the transferability. The promotion of point contact between the toner and the photosensitive member reduces the adhesive force of the toner to the photosensitive member, and hence can improve the transferability. Meanwhile, when the particle diameters of the insulating particles are excessively reduced, as described above, the distance between the photosensitive member and the toner cannot be sufficiently lengthened, and hence the adhesive force of the toner to the photosensitive member, specifically, a drum becomes larger. When the average primary particle diameter of the insulating particles is represented by D1 [nm], the D1 is preferably 60 or more and 180 or less as represented by the following formula.

60≤D1≤180 (11)

The control of the particle diameters of the electroconductive particles can further alleviate image smearing. When the particle diameters of the electroconductive particles are excessively increased, a conductive path along a film serving as the surface layer of the photosensitive member is liable to be formed, and hence the initial image smearing worsens. When the average primary particle diameter of the electroconductive particles is represented by D2 [nm], the D2 is preferably 70 or less as represented by the following formula.

D2≤70 (12)

Herein, the ratio “D1/D2” of the average primary particle diameter D1 of the insulating particles to the average primary particle diameter D2 of the electroconductive particles is preferably 1.2 or more as represented by the following formula.

1.2≤D1/D2 (9)

The ratio is preferably 2.8 or less as represented by the following formula.

D1/D2≤2.8 (10)

Further, the ratio of the total sum of the volumes of the electroconductive particles and the insulating particles to the total volume of the surface layer is preferably 40% or more. When the ratios are controlled within the ranges, the above-mentioned exposed heights can be controlled within more appropriate ranges, and hence the transferability and injection chargeability of the photosensitive member can be further improved.

The above-mentioned mechanism is based on an assumption.

Herein, in the present invention, the exposed heights L1 [nm] and L2 [nm] of the respective particles were measured through sectional observation with a FIB-SEM ([NVision], manufactured by Carl Zeiss AG). Sections of electrophotographic photosensitive members produced in Examples were observed. The observation was performed at 3 sites for each of the samples, and the maximum of the heights of the insulating particles or the electroconductive particles exposed to a portion above the surface of the binder resin of the surface layer of each sample with respect to the average height of the surface of the binder resin was measured for each image. The resultant 3 values were averaged, and the average exposed height of the insulating particles and that of the electroconductive particles were represented by L1 [nm] and L2 [nm], respectively (see FIG. 4). The electroconductive particles and the insulating particles were distinguished from each other by using the SEM-EDX function of the FIB-SEM. Positions corresponding to ¼, ½, and ¾ of the length of the photosensitive member from above when the photosensitive member was divided into 4 equal sections in its longitudinal direction were used as the 3 sites at which the sectional observation was performed, and the observation was performed while the positions were shifted from each other by 120° in the peripheral direction thereof. In addition, the surface shape of the photosensitive member was measured with a scanning probe microscope (“JSPM-5200”, manufactured by JEOL Ltd.), and it was recognized that the surface shape coincided with the results of the measurement with the FIB-SEM. A distinction between the particles in the measurement with the scanning probe microscope was performed as follows: measured positions were marked after the measurement, and the particles were distinguished from each other by using the EDX function of a scanning electron microscope (hereinafter also referred to as “SEM”, “JSM-7800F”, manufactured by JEOL Ltd.).

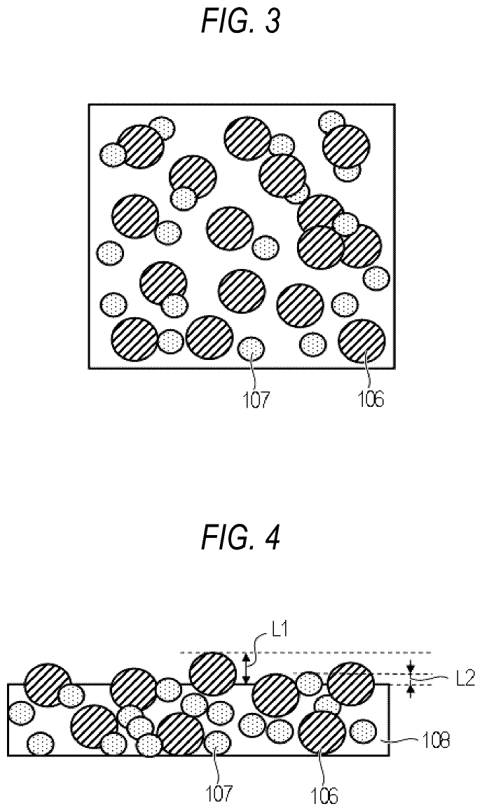

In addition, the exposed areas S1 [%] and S2 [%] of the respective particles were measured through surface observation with a FIB-SEM. The electrophotographic photosensitive members produced in Examples were each cut into a size measuring about 5 mm square. The surface layer of the photosensitive member was observed from above with the SEM, and the images of 3 sites were taken for each photosensitive member. The resultant images were subjected to image processing, and the ratio of the gross area of insulating particle portions to the total observed area and the ratio of the gross area of electroconductive particle portions to the total observed area were represented by S1 [%] and S2 [%], respectively (see FIG. 3). The electroconductive particles and the insulating particles were distinguished from each other by using the SEM-EDX function of the SEM. Positions corresponding to ¼, ½, and ¾ of the length of the photosensitive member from above when the photosensitive member was divided into 4 equal sections in its longitudinal direction were used as the 3 sites at which the surface observation was performed, and the observation was performed while the positions were shifted from each other by 120° in the peripheral direction thereof. In addition, the surface shape of the photosensitive member was measured with a scanning probe microscope (“JSPM-5200”, manufactured by JEOL Ltd.), and it was recognized that the surface shape coincided with the results of the measurement with the FIB-SEM. A distinction between the particles in the measurement with the scanning probe microscope was performed as follows: measured positions were marked after the measurement, and the particles were distinguished from each other by using the EDX function of a scanning electron microscope (hereinafter also referred to as “SEM”, “JSM-7800F”, manufactured by JEOL Ltd.).

As described above, the particles of the surface layer of the electrophotographic photosensitive member of the present invention need to contain the insulating particles and the electroconductive particles. The insulating particles and the electroconductive particles are distinguished from each other by their volume resistivities. For example, the volume resistivity of a metal oxide may be changed by subjecting the metal oxide to surface treatment or doping the metal oxide with an element, such as phosphorus, aluminum, or niobium, or an oxide thereof, and the resultant product may be used as the insulating particles, or may be used as the electroconductive particles.

The average circularity of the insulating particles is preferably 0.95 or more and 1.0 or less for promoting point contact between the toner and the photosensitive member.

The average circularity of the particles was determined with a scanning electron microscope as described below. The particles to be subjected to measurement were observed with the scanning electron microscope (“JSM-7800F”, manufactured by JEOL Ltd.), and the particle diameters of 100 individual particles were measured from an image obtained through the observation. The longest side “a” and shortest side “b” of a primary particle were measured for each of the particles, and the ratio “b/a” was adopted as a circularity. The circularities of the 100 particles were averaged to calculate the average circularity.

Examples of the particles to be used in the present invention include: organic resin particles such as acrylic resin particles; inorganic particles made of silica, aluminum oxide, or the like; and organic-inorganic hybrid particles.

Examples of the organic resin particles include crosslinked polystyrene, a crosslinked acrylic resin, a phenol resin, a melamine resin, polyethylene, polypropylene, acrylic particles, polytetrafluoroethylene particles, and silicone particles.

The acrylic particles each contain a polymer of an acrylic acid ester or a methacrylic acid ester. Of those, styrene acrylic particles are more preferred. There is no particular limitation on the polymerization degree of an acrylic resin or a styrene acrylic resin, or on whether the resin is thermoplastic or thermosetting.

The polytetrafluoroethylene particles only need to be particles formed mainly of a tetrafluoroethylene resin, and the particles may each contain a trifluorochloroethylene resin, a hexafluoropropylene resin, a vinyl fluoride resin, a vinylidene fluoride resin, a difluorodichloroethylene resin, or the like in addition to the tetrafluoroethylene resin.

Examples of the inorganic particles include silica particles, metal oxide particles, and metal particles. Inorganic particles, which have low elasticity, and are advantageous in terms of the promotion of point contact between the toner and the photosensitive member, are preferably used as the particles of the surface layer of the electrophotographic photosensitive member of the present invention.

When the inorganic particles are used as the insulating particles, silica particles out of the particles are preferred. The silica particles are expected to exhibit the following effect because the particles have a lower elastic modulus and a larger average circularity than those of the other insulating particles: the particles promote the point contact between the toner and the photosensitive member to alleviate the adhesive force of the toner.

Known silica fine particles may be used as the silica particles, and the fine particles of dry silica and the fine particles of wet silica may each be used. Of those, the fine particles of wet silica obtained by a sol-gel method (hereinafter also referred to as “sol-gel silica”) are preferred.

The sol-gel silica used as the particles to be incorporated into the surface layer of the electrophotographic photosensitive member of the present invention may be hydrophilic, or its surface may be subjected to hydrophobic treatment.

A method for the hydrophobic treatment is, for example, a method including removing a solvent from a silica sol suspension in the sol-gel method to dry the suspension, and then treating the dried product with a hydrophobic treatment agent, or a method including directly adding the hydrophobic treatment agent to the silica sol suspension to dry and treat the suspension simultaneously. Of those, an approach including directly adding the hydrophobic treatment agent to the silica sol suspension is preferred from the viewpoints of the control of the half-width of the particle size distribution of the sol-gel silica and the control of the saturated moisture adsorption amount thereof.

Examples of the hydrophobic treatment agent include the following:
chlorosilanes, such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes, such as tetramethoxysilane, methyltrimethoxysilane, dimethyldimethoxysilane, phenyltrimethoxysilane, diphenyldimethoxysilane, o-methylphenyltrimethoxysilane, p-methylphenyltrimethoxysilane, n-butyltrimethoxysilane, i-butyltrimethoxysilane, hexyltrimethoxysilane, octyltrimethoxysilane, decyltrimethoxysilane, dodecyltrimethoxysilane, tetraethoxysilane, methyltriethoxysilane, dim ethyl di ethoxy silane, phenyltriethoxysilane, diphenyldiethoxysilane, i-butyltriethoxysilane, decyltriethoxysilane, vinyltriethoxysilane, γ-methacryloxypropyltrimethoxysilane, γ-glycidoxypropyltrimethoxysilane, γ-glycidoxypropylmethyldimethoxysilane, γ-mercaptopropyltrimethoxysilane, γ-chloropropyltrimethoxysilane, γ-aminopropyltrimethoxy silane, γ-aminopropyltriethoxysilane, γ-(2-aminoethyl)aminopropyltrimethoxysilane, and γ-(2-aminoethyl)aminopropylmethyldimethoxysilane;
silazanes, such as hexamethyldisilazane, hexaethyldisilazane, hexapropyldisilazane, hexabutyldisilazane, hexapentyldisilazane, hexahexyldisilazane, hexacyclohexyldisilazane, hexaphenyldisilazane, divinyltetramethyldisilazane, and dimethyltetravinyldisilazane;
silicone oils, such as a dimethyl silicone oil, a methyl hydrogen silicone oil, a methyl phenyl silicone oil, an alkyl-modified silicone oil, a chloroalkyl-modified silicone oil, a chlorophenyl-modified silicone oil, a fatty acid-modified silicone oil, a polyether-modified silicone oil, an alkoxy-modified silicone oil, a carbinol-modified silicone oil, an amino-modified silicone oil, a fluorine-modified silicone oil, and an end reactive silicone oil;
siloxanes, such as hexamethylcyclotrisiloxane, octamethylcyclotetrasiloxane, decamethylcyclopentasiloxane, hexamethyldisiloxane, and octamethyltrisiloxane; and
as fatty acids and metal salts thereof, long-chain fatty acids, such as undecylic acid, lauric acid, tridecylic acid, dodecylic acid, myristic acid, palmitic acid, pentadecylic acid, stearic acid, heptadecylic acid, arachic acid, montanic acid, oleic acid, linoleic acid, and arachidonic acid, and salts of those fatty acids and metals, such as zinc, iron, magnesium, aluminum, calcium, sodium, and lithium.

Of those, alkoxysilanes, silazanes, and silicone oils are each preferably used because the hydrophobic treatment is easily performed. Those hydrophobic treatment agents may be used alone or in combination thereof.

When the inorganic particles are used as the electroconductive particles, metal oxide particles are desirably used.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, in particular, titanium oxide, tin oxide, and zinc oxide are more preferably used.

The surface of the metal oxide may be treated with a silane coupling agent or the like, or the metal oxide may be doped with an element, such as phosphorus, aluminum, or niobium, or an oxide thereof. The doping can control the resistance of the metal oxide, and hence the metal oxide can be used as the insulating particles or as the electroconductive particles.

The electroconductive particles may each have a laminate configuration including a core particle and a covering layer that covers the core particle. Examples of the core particle include titanium oxide, barium sulfate, zinc oxide, and indium oxide. Examples of the covering layer include metal oxides, such as tin oxide and titanium oxide.

The electroconductive particles are particularly preferably niobium-containing titanium oxide particles.

Particles each having any of various shapes, such as a spherical shape, a polyhedral shape, an ellipsoidal shape, a flaky shape, and a needle shape, may be used as the niobium-containing titanium oxide particles. Of those, particles each having a spherical shape, a polyhedral shape, or an ellipsoidal shape are preferred from the viewpoint that image defects such as black spots are reduced.

The niobium-containing titanium oxide particles are preferably particles of anatase-type or rutile-type titanium oxide, more preferably particles of anatase-type titanium oxide. The anatase-type titanium oxide preferably has an anatase degree of 90% or more. The use of the anatase-type titanium oxide smooths charge movement in the surface layer of the electrophotographic photosensitive member to improve the injection chargeability thereof.

In the present invention, the electroconductive particles are particularly preferably particles including anatase-type titanium oxide particles serving as a core and titanium oxide that covers the surface of the core and contains niobium. Specific examples thereof include particles obtained by doping particles of a metal oxide having a titanium atom with a niobium atom or a niobium oxide. Niobium is preferably contained as a niobium atom in a so-called doped form, in which niobium is incorporated into a crystal lattice of titanium oxide, instead of being contained as an oxide. When titanium oxide is doped with niobium, the injection chargeability is enhanced.

When the metal oxide particles include the niobium-containing titanium oxide particles, the content of niobium with respect to the total mass of the metal oxide particles is preferably 0.5 mass % or more and 15.0 mass % or less, more preferably 2.6 mass % or more and 10.0 mass % or less. When the content of niobium with respect to the total mass of the metal oxide particles is 0.5 mass % or more, the electroconductivity of titanium oxide can be increased, and the injection chargeability can be enhanced. When the content is 15.0 mass % or less, the crystal structure of titanium oxide can be maintained, and hence the volume resistivity of the surface layer does not become excessively large.

When the metal oxide particles include the niobium-containing titanium oxide particles, the atomic concentration ratio of a niobium atom to a titanium atom may be determined as described below. First, the electroconductive particles are subjected to surface composition analysis by X-ray photoelectron spectroscopy (XPS), and the content ratio of each atom is calculated based on the obtained results. An apparatus and measurement conditions for the XPS are as described below.

Apparatus used: Quantum 2000 manufactured by ULVAC-PHI, Inc.
Analysis method: narrow analysis
X-ray source: Al-Kα
X-ray conditions: 100 μm, 25 W, 15 kV
Photoelectron acceptance angle: 45°

### Pass Energy: 58.70 eV

Measurement range: φ100 μm

Measurement is performed under the above-mentioned conditions, and a peak derived from a C—C bond of carbon is orbitals is corrected to 285 eV. After that, a relative sensitivity factor provided by ULVAC-PHI, Inc. is applied to the peak area of an atom having a peak top detected at from 100 eV to 103 eV. The respective spectral peaks of the titanium atom and the niobium atom are integrated and converted to calculate a titanium atom concentration and a niobium atom concentration. From the resultant values of the respective atom concentrations, the atomic concentration ratio of the niobium atom to the titanium atom is calculated.

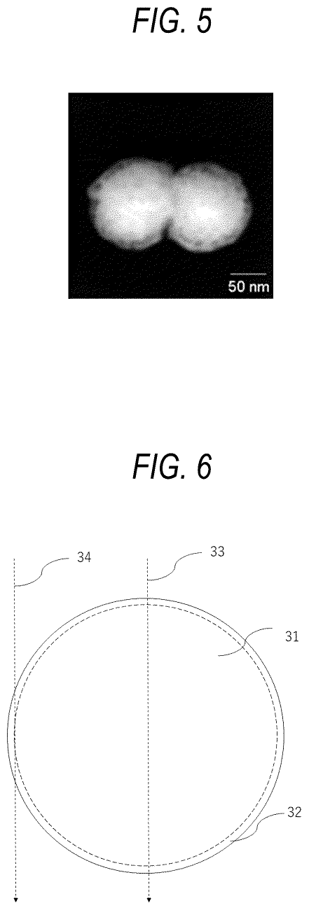

The electroconductive particles are particularly preferably titanium oxide particles each of which contains a niobium atom, and has a configuration in which niobium is localized in the vicinity of the surface of the particle. This is because the localization of the niobium atom in the vicinity of the surface enables efficient transfer of charge. More specifically, in each of the titanium oxide particles, a concentration ratio calculated as “niobium atom concentration/titanium atom concentration” at an inside portion at 5% of the maximum diameter of the particle from the surface of the particle is 2.0 or more times as high as a concentration ratio calculated as “niobium atom concentration/titanium atom concentration” at the center of the particle. The niobium atom concentration and the titanium atom concentration are obtained through use of a scanning transmission electron microscope (STEM) having connected thereto an energy-dispersive X-ray spectroscopy (EDS) analyzer. A STEM image of an example (Xi) of titanium oxide particles used in Examples of the present invention is shown in FIG. 5. In addition, the STEM image of FIG. 5 is schematically illustrated in FIG. 6. As described in detail later, niobium-containing titanium oxide particles used in Examples according to the present invention are produced by coating titanium oxide particles with niobium-containing titanium oxide, followed by firing. Accordingly, the coating niobium-containing titanium oxide is conceived to undergo crystal growth as niobium-doped titanium oxide through so-called epitaxial growth along a crystal of the titanium oxide serving as a core. As illustrated in FIG. 6, the thus produced titanium oxide containing niobium has a lower density in the vicinity of the surface than that at the central portion of the particle, and hence is controlled to have a core-shell-like form.

In each of such niobium-containing titanium oxide particles, the niobium/titanium atomic concentration ratio in a vicinity 32 of the surface of the particle is higher than the niobium/titanium atomic concentration ratio at a central portion 31 of the particle, and the niobium atom is localized in the vicinity of the surface of the particle. Specifically, the niobium/titanium atomic concentration ratio at the inside portion at 5% of the maximum diameter of the particle from the surface of the particle is 2.0 or more times as high as the niobium/titanium atomic concentration ratio at the central portion 31 of the particle. When the ratio between the niobium/titanium atomic concentration ratios is set to 2.0 or more times, charge can be easily injected from a charging member brought into contact with the surface of each of the electroconductive particles, and the charge can easily move in the surface layer, and hence a suppressing effect on a reduction in resistivity of the electrophotographic photosensitive member can be enhanced. When the niobium/titanium atomic concentration ratio is less than 2.0 times, charge is not easily transferred.

The EDS analysis with the STEM involves observation with a transmission electron microscope and measurement of the niobium/titanium atomic concentration ratios by EDS analysis. An X-ray 33 that analyzes the central portion of the particle can measure the niobium/titanium atomic concentration ratio at the central portion 31 of the particle. In addition, an X-ray 34 that analyzes an inside portion at 5% of the primary particle diameter of the particle from the surface of the particle can measure the niobium/titanium atomic concentration ratio at the inside portion at 5% of the maximum diameter of the particle from the surface of the particle. In addition, the niobium/titanium atomic concentration ratios may be directly measured from the electrophotographic photosensitive member through the slicing of the electrophotographic photosensitive member by a method, such as a microtome, Ar milling, or a FIB.

In addition, the electroconductive particles preferably have an average primary particle diameter of 60 nm or more and 150 nm or less. When the electroconductive particles have an average primary particle diameter of 60 nm or more, the specific surface area of the electroconductive particles does not become excessively large, and hence the adsorption of moisture onto the electroconductive particles exposed on the surface of the electrophotographic photosensitive member can be suppressed. When the electroconductive particles have an average primary particle diameter of 150 nm or less, the dispersibility of the electroconductive particles in the surface layer can be increased. In addition, the area of an interface with the binder resin in the surface layer can be increased, and hence resistance between the electroconductive particles and the binder resin is reduced to increase the efficiency of movement of charge, to thereby improve the injection chargeability of the electrophotographic photosensitive member.

In addition, the electroconductive particles are surface-treated with a compound having a silicon atom, such as a silane coupling agent or a silicone resin. Through the surface treatment, the hydrophobicity of the electroconductive particles is increased. In addition, through the surface treatment, nonuniform dispersion of the electroconductive particles in the surface layer is suppressed to suppress a reduction in resistance caused by excessive exposure of the electroconductive particles on the surface of the electrophotographic photosensitive member. As a result of the foregoing, the adsorption of moisture onto the surface of the electrophotographic photosensitive member under a high-humidity environment can be suppressed.

The compound having a silicon atom to be used for the surface treatment of the electroconductive particles preferably contains an alkyl group having 12 or less carbon atoms.

A silane coupling agent is suitably used for the surface treatment of the electroconductive particles. A compound represented by the following formula (A) may be used as the silane coupling agent.

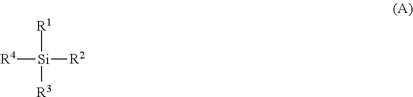

In the formula (A), R¹ to R³ each independently represent an alkoxy group or an alkyl group, provided that at least two of R¹ to R³ represent alkoxy groups. R⁴ represents an alkyl group having 12 or less carbon atoms.

Examples of the compound represented by the formula (A) include hexyltrimethoxysilane, hexyltriethoxysilane, octyltrimethoxysilane, octyltriethoxysilane, decyltrimethoxysilane, dodecyltrimethoxysilane, and dodecyltriethoxysilane.

In addition, as the silane coupling agent, a silane coupling agent except the compound represented by the formula (A), such as N-2-(aminoethyl)-3-aminopropylmethyldimethoxysilane, 3-aminopropylmethyldiethoxysilane, (phenylaminomethyl)methyldimethoxysilane, N-2-(aminoethyl)-3-aminoisobutylmethyldimethoxysilane, N-ethylaminoisobutylmethyldiethoxysilane, N-methylaminopropylmethyldimethoxysilane, vinyltrimethoxysilane, 3-aminopropyltriethoxysilane, N-(2-aminoethyl)-3-aminopropyltrimethoxysilane, methyltrimethoxysilane, 3-glycidoxypropyltrimethoxysilane, 3-methacryloxypropyltrimethoxysilane, 3-chloropropyltrimethoxysilane, or 3-mercaptopropyltrimethoxysilane, may be used in combination with the compound represented by the formula (A).

A general method is used as a method of surface-treating the electroconductive particles. Examples thereof include a dry method and a wet method.

The dry method involves, while stirring the electroconductive particles in a mixer capable of high-speed stirring such as a Henschel mixer, adding an alcoholic aqueous solution, organic solvent solution, or aqueous solution containing the surface treatment agent, uniformly dispersing the mixture, and then drying the dispersion.

In addition, the wet method involves stirring the electroconductive particles and the surface treatment agent in a solvent, or dispersing the electroconductive particles and the surface treatment agent in a solvent with a sand mill or the like using glass beads or the like. After the dispersion, the solvent is removed by filtration or evaporation under reduced pressure. After the removal of the solvent, it is preferred to further perform baking at 100° C. or more.

In addition, a charge-transporting material may be added to a coating liquid for a surface layer for the purpose of improving the charge-transporting ability of the surface layer. In addition, additives may be added for the purpose of improving the various functions of the layer. Examples of the additives include electroconductive particles, an antioxidant, a UV absorber, a plasticizer, and a leveling agent.

The binder resin according to the present invention comes in the following forms. Herein, the surface layer preferably contains the charge-transporting material.

Examples of the charge-transporting material include a polycyclic aromatic compound, a heterocyclic compound, a hydrazone compound, a styryl compound, an enamine compound, a benzidine compound, a triarylamine compound, and a resin having a group derived from each of those materials. Of those, a triarylamine compound and a benzidine compound are preferred.

In addition, examples of the resin to be incorporated include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the surface layer may be formed as a cured film by polymerizing a composition containing a monomer having a polymerizable functional group. A reaction in this case is, for example, a thermal polymerization reaction, a photopolymerization reaction, or a radiation polymerization reaction. Examples of the polymerizable functional group of the monomer having a polymerizable functional group include an acryloyl group and a methacryloyl group. A material having a charge-transporting ability may be used as the monomer having a polymerizable functional group.

<Support>

In the present invention, the electrophotographic photosensitive member preferably includes a support. In the present invention, the support is preferably an electroconductive support having electroconductivity. In addition, examples of the shape of the support include a cylindrical shape, a belt shape, and a sheet shape. Of those, a cylindrical support is preferred. In addition, the surface of the support may be subjected to, for example, electrochemical treatment such as anodization, blast treatment, or cutting treatment.

A metal, a resin, glass, or the like is preferred as a material for the support.

Examples of the metal include aluminum, iron, nickel, copper, gold, stainless steel, and alloys thereof. Of those, an aluminum support using aluminum is preferred.

In addition, electroconductivity may be imparted to the resin or the glass through treatment involving, for example, mixing or coating with an electroconductive material.

<Electroconductive Layer>

In the present invention, an electroconductive layer may be arranged on the support. The arrangement of the electroconductive layer can conceal flaws and unevenness in the surface of the support, and control the reflection of light on the surface of the support.

The electroconductive layer preferably contains electroconductive particles and a resin.

A material for the electroconductive particles is, for example, a metal oxide, a metal, or carbon black.

Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, the metal oxide is preferably used as the electroconductive particles, and in particular, titanium oxide, tin oxide, and zinc oxide are more preferably used.

When the metal oxide is used as the electroconductive particles, the surface of the metal oxide may be treated with a silane coupling agent or the like, or the metal oxide may be doped with an element, such as phosphorus or aluminum, or an oxide thereof.

In addition, the electroconductive particles may each have a laminate configuration including a core particle and a covering layer that covers the core particle. Examples of the core particle include titanium oxide, barium sulfate, and zinc oxide.

An example of the covering layer is a metal oxide such as tin oxide.

In addition, when the metal oxide is used as the electroconductive particles, their average primary particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the electroconductive layer may further contain, for example, a concealing agent, such as a silicone oil, resin particles, or titanium oxide.

The electroconductive layer has an average thickness of preferably 1 μm or more and 50 μm or less, particularly preferably 3 μm or more and 40 μm or less.

The electroconductive layer may be formed by: preparing a coating liquid for an electroconductive layer containing the above-mentioned materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. A dispersion method for dispersing the electroconductive particles in the coating liquid for an electroconductive layer is, for example, a method involving using a paint shaker, a sand mill, a ball mill, or a liquid collision-type high-speed disperser.

<Undercoat Layer>

In the present invention, an undercoat layer may be arranged on the support or the electroconductive layer.

The undercoat layer has an average thickness of preferably 0.1 μm or more and 50 μm or less, more preferably 0.2 μm or more and 40 μm or less, particularly preferably 0.3 μm or more and 30 μm or less.

A resin for the undercoat layer is, for example, a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamic acid resin, a polyurethane resin, a polyimide resin, a polyamideimide resin, a polyvinylphenol resin, a melamine resin, a phenol resin, an epoxy resin, and an alkyd resin.

A resin having a structure in which a resin having a polymerizable functional group and a monomer having a polymerizable functional group are crosslinked with each other is also permitted.

In addition, the undercoat layer may contain an inorganic compound or an organic compound in addition to the resin.

Examples of the inorganic compound include a metal, an oxide, and a salt.

Examples of the metal include gold, silver, and aluminum. Examples of the oxide include zinc oxide, white lead, aluminum oxide, indium oxide, silicon oxide, zirconium oxide, tin oxide, titanium oxide, magnesium oxide, antimony oxide, bismuth oxide, indium oxide, tin oxide, and zirconium oxide. Examples of the salt include barium sulfate and strontium titanate.

Those inorganic compounds may each be present under a particle state in a film serving as the undercoat layer.

The number-average particle diameter of the particles of the inorganic compound is preferably 1 nm or more and 500 nm or less, more preferably 3 nm or more and 400 nm or less.

Those inorganic compounds may each have a laminated configuration including a core particle and a covering layer covering the particle.

The surfaces of those inorganic compounds may each be treated with, for example, a silicone oil, a silane compound, a silane coupling agent, or any other organosilicon compound, or an organotitanium compound. In addition, those inorganic compounds may each be doped with an element, such as tin, phosphorus, aluminum, or niobium.

Examples of the organic compound include an electron-transporting compound and an electroconductive polymer.

Examples of the electroconductive polymer include polythiophene, polyaniline, polyacetylene, polyphenylene, and polyethylenedioxythiophene.

Examples of the electron-transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound.

The electron-transporting material may have a polymerizable functional group and may be crosslinked with a resin having a functional group reactive with the functional group. Examples of the polymerizable functional group include a hydroxy group, a thiol group, an amino group, a carboxyl group, a vinyl group, an acryloyl group, a methacryloyl group, and an epoxy group.

Those organic compounds may each be present under a particle state in the film, or their surfaces may be treated.

Various additives including a leveling agent such as a silicone oil, a plasticizer, and a thickener may be added to the undercoat layer.

The undercoat layer is obtained by: preparing a coating liquid for an undercoat layer containing the above-mentioned materials; then applying the coating liquid onto the support or the electroconductive layer; and then drying or curing the coat.

A solvent at the time of the production of the coating liquid is, for example, an alcohol-based solvent, a ketone-based solvent, an ether-based solvent, an ester-based solvent, or an aromatic hydrocarbon-based solvent.

A dispersion method for dispersing the particles of the materials in the coating liquid is, for example, a method involving using a paint shaker, a sand mill, a ball mill, or a liquid collision-type high-speed disperser.

<Photosensitive Layer>

The photosensitive layers of the electrophotographic photosensitive member are mainly classified into (1) a laminate-type photosensitive layer and (2) a monolayer-type photosensitive layer. (1) The laminate-type photosensitive layer has a charge-generating layer containing a charge-generating material and a charge-transporting layer containing a charge-transporting material. (2) The monolayer-type photosensitive layer has a photosensitive layer containing both a charge-generating material and a charge-transporting material.

(1) Laminate-Type Photosensitive Layer

The laminate-type photosensitive layer has the charge-generating layer and the charge-transporting layer.

(1-1) Charge-Generating Layer

The charge-generating layer preferably contains the charge-generating material and a resin.

Examples of the charge-generating material include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating material in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is more preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer has an average thickness of preferably 0.1 μm or more and 1 μm or less, more preferably 0.15 μm or more and 0.4 μm or less.

The charge-generating layer may be formed by: preparing a coating liquid for a charge-generating layer containing the above-mentioned materials and a solvent; forming a coat of the coating liquid; and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

(1-2) Charge-Transporting Layer

The charge-transporting layer preferably contains the charge-transporting material and a resin.

Examples of the charge-transporting material include a polycyclic aromatic compound, a heterocyclic compound, a hydrazone compound, a styryl compound, an enamine compound, a benzidine compound, a triarylamine compound, and a resin having a group derived from each of those materials. Of those, a triarylamine compound and a benzidine compound are preferred.

The content of the charge-transporting material in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting material and the resin is preferably from 4:10 to 20:10, more preferably from 5:10 to 12:10.

In addition, the charge-transporting layer may contain an additive, such as an antioxidant, a UV absorber, a plasticizer, a leveling agent, a slipperiness-imparting agent, or an abrasion resistance-improving agent. Specific examples thereof include a hindered phenol compound, a hindered amine compound, a sulfur compound, a phosphorus compound, a benzophenone compound, a siloxane-modified resin, a silicone oil, fluororesin particles, polystyrene resin particles, polyethylene resin particles, silica particles, alumina particles, and boron nitride particles.

The charge-transporting layer has an average thickness of 5 μm or more and 50 μm or less, more preferably 8 μm or more and 40 μm or less, particularly preferably 10 μm or more and 30 μm or less.

The charge-transporting layer may be formed by: preparing a coating liquid for a charge-transporting layer containing the above-mentioned materials and a solvent; forming a coat of the coating liquid; and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

When the charge-transporting layer is used as the surface layer, the particles described in the above-mentioned section <Surface Layer> are used.

(2) Monolayer-Type Photosensitive Layer

The monolayer-type photosensitive layer may be formed by: preparing a coating liquid for a photosensitive layer containing the charge-generating material, the charge-transporting material, a resin, and a solvent; forming a coat of the coating liquid; and drying the coat. Examples of the charge-generating material, the charge-transporting material, and the resin are the same as those of the materials in the section “(1) Laminate-type Photosensitive Layer.”

<Protection Layer>

In the present invention, a case in which a protection layer is arranged on the photosensitive layer is preferred. In this case, the protection layer serves as the surface layer. The arrangement of the protection layer can improve the durability of the photosensitive member.

The protection layer preferably contains electroconductive particles and/or a charge-transporting material, and a resin.

Examples of the electroconductive particles include the particles of metal oxides, such as titanium oxide, zinc oxide, tin oxide, and indium oxide.

Examples of the charge-transporting material include a polycyclic aromatic compound, a heterocyclic compound, a hydrazone compound, a styryl compound, an enamine compound, a benzidine compound, a triarylamine compound, and a resin having a group derived from each of those materials. Of those, a triarylamine compound and a benzidine compound are preferred.

Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

In addition, the protection layer may be formed as a cured film by polymerizing a composition containing a monomer having a polymerizable functional group. A reaction in this case is, for example, a thermal polymerization reaction, a photopolymerization reaction, or a radiation polymerization reaction. Examples of the polymerizable functional group of the monomer having a polymerizable functional group include an acryloyl group and a methacryloyl group. A material having a charge-transporting ability may be used as the monomer having a polymerizable functional group.

The protection layer may contain an additive, such as an antioxidant, a UV absorber, a plasticizer, a leveling agent, a slipperiness-imparting agent, or an abrasion resistance-improving agent. Specific examples of the additive include a hindered phenol compound, a hindered amine compound, a sulfur compound, a phosphorus compound, a benzophenone compound, a siloxane-modified resin, and a silicone oil.

It is preferred that the particles described in the above-mentioned section <Surface Layer> be used as the particles used for the protection layer.

The protection layer has an average thickness of preferably 0.2 μm or more and 10 μm or less, more preferably 0.3 μm or more and 7 μm or less.

The protection layer may be formed by: preparing a coating liquid for a protection layer containing the above-mentioned materials and a solvent; forming a coat of the coating liquid; and drying and/or curing the coat. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

[Process Cartridge and Electrophotographic Apparatus]

A process cartridge of the present invention may integrally support the electrophotographic photosensitive member described in the foregoing, and at least one unit selected from the group consisting of: a charging unit; a developing unit; and a cleaning unit. The process cartridge is characterized by being detachably attachable onto the main body of an electrophotographic apparatus. An electrophotographic apparatus of the present invention may include the above-mentioned electrophotographic photosensitive member, a charging unit, an exposing unit, a developing unit, and a transfer unit.

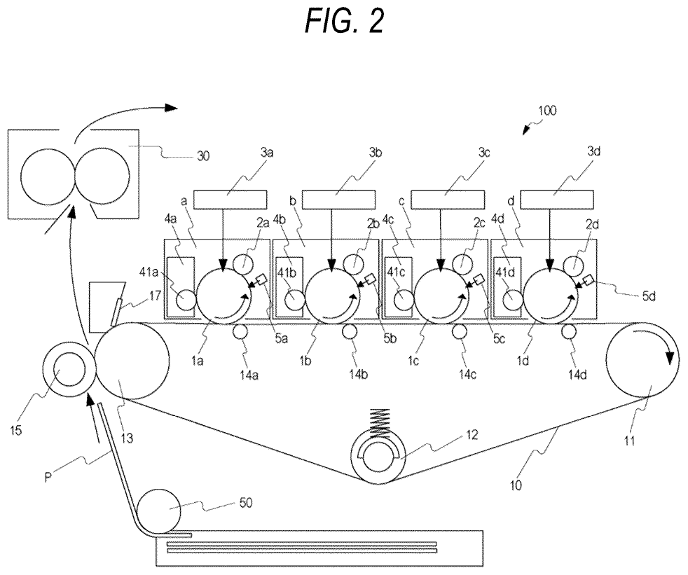

An example of the schematic configuration of an electrophotographic apparatus including a process cartridge including the electrophotographic photosensitive member of the present invention is illustrated in FIG. 2.

[Configuration of Electrophotographic Apparatus]

An electrophotographic apparatus of this embodiment is a so-called tandem-type electrophotographic apparatus provided with a plurality of image forming portions “a” to “d”. A first image forming portion “a” forms an image with a toner of yellow (Y). A second image forming portion “b” forms an image with a toner of magenta (M). A third image forming portion “c” forms an image with a toner of cyan (C). A fourth image forming portion “d” forms an image with a toner of black (Bk). Those four image forming portions are arranged in a row at constant intervals, and the configurations of the respective image forming portions are substantially the same in many respects except the color of a toner to be stored. Thus, the electrophotographic apparatus of this embodiment is described below through use of the first image forming portion “a”.

The first image forming portion “a” includes a photosensitive drum 1a that is a drum-shaped electrophotographic photosensitive member, a charging roller 2a that is a charging member, a developing unit 4a, and electricity-removing units 5a.

The photosensitive drum 1a is an image-bearing member that bears a toner image, and is rotationally driven in a direction indicated by the arrow illustrated in the figure at a predetermined peripheral speed (process speed). The developing unit 4a stores a yellow toner and develops the yellow toner on the photosensitive drum 1a.

An image forming operation is started when a control unit (not shown) such as a controller receives an image signal, and the photosensitive drum 1a is rotationally driven. During the rotation process, the photosensitive drum 1a is uniformly charged to a predetermined voltage (charging voltage) with a predetermined polarity (negative polarity in this embodiment) by the charging roller 2a, and is exposed by an exposing unit 3a in accordance with the image signal. Thus, an electrostatic latent image corresponding to a yellow color component image of a target color image is formed on the photosensitive drum 1a. Then, the electrostatic latent image is developed by the developing unit 4a at a developing position and visualized as a yellow toner image on the photosensitive drum 1a. Here, the normal charging polarity of the toner stored in the developing unit 4a is a negative polarity, and the electrostatic latent image is subjected to reversal development with the toner charged to the same polarity as the charging polarity of the photosensitive drum 1a by the charging roller 2a. However, the present invention is not limited thereto, and the present invention may be applied also to an electrophotographic apparatus in which an electrostatic latent image is subjected to normal development with a toner charged to a polarity opposite to the charging polarity of the photosensitive drum 1a. In addition, many convex portions derived from particles may be arranged on the surface layer of the charging roller 2a. The convex portions arranged on the surface layer of the charging roller 2a each have a role as a spacer between the charging roller 2a and the photosensitive drum 1a in a charging portion. The role is as follows: when transfer residual toner, which is toner remaining on the photosensitive drum 1a without being transferred in a primary transfer portion to be described later, enters the charging portion, the contamination of the charging roller 2a with the transfer residual toner due to the contact of a site except the convex portions with the transfer residual toner is suppressed.

A pre-exposing unit 5a serving as an electricity-removing unit exposes the surface of the photosensitive drum 1a before the charging of the surface of the photosensitive drum 1a by the charging roller 2a to light to remove electricity therefrom. The unit removes the electricity from the surface of the photosensitive drum 1a to play a role of leveling a surface potential formed on the photosensitive drum 1a and a role of controlling the quantity of electricity discharged by discharge occurring in the charging portion.

An endless and movable intermediate transfer belt 10 has electroconductivity, is brought into contact with the photosensitive drum 1a to form a primary transfer portion, and is rotated at substantially the same peripheral speed as that of the photosensitive drum 1a. In addition, the intermediate transfer belt 10 is tensioned by a counter roller 13 serving as a counter member, a drive roller 11 and a tension roller 12 each serving as a tension member, and a metal roller 14a, and is tensioned by the tension roller 12 under a tension of a total pressure of 60 N. The intermediate transfer belt 10 can be moved when the drive roller 11 is rotationally driven in a direction indicated by the arrow illustrated in the figure.

The yellow toner image formed on the photosensitive drum 1a is primarily transferred from the photosensitive drum 1a to the intermediate transfer belt 10 in the process of passing through the primary transfer portion.

During the primary transfer, a current is supplied to the electroconductive intermediate transfer belt 10 from a secondary transfer roller 15 serving as a secondary transfer member that is brought into contact with an outer peripheral surface of the intermediate transfer belt 10. When the current supplied from the secondary transfer roller 15 flows in a peripheral direction of the intermediate transfer belt 10, the toner image is primarily transferred from the photosensitive drum 1a to the intermediate transfer belt 10. In this case, a voltage (not shown) having a predetermined polarity (positive polarity in this embodiment) opposite to the normal charging polarity of the toner is applied to the secondary transfer roller 15 from a transfer power source (not shown). The second, third, and fourth image forming portions in FIG. 2 include photosensitive drums 1b, 1c, and 1d, charging rollers 2b, 2c, and 2d, exposing units 3b, 3c, and 3d, developing units 4b, 4c, and 4d, electricity-removing units 5b, 5c, and 5d, and metal rollers 14b, 14c, and 14d, respectively. The developing units 4a, 4b, 4c, and 4d include developing rollers 41a, 41b, 41c, and 41d, respectively.

Subsequently, a magenta toner image of the second color, a cyan toner image of the third color, and a black toner image of the fourth color are formed in the same manner, and are sequentially transferred onto the intermediate transfer belt 10 so as to be superimposed on one another. Thus, toner images of four colors corresponding to target color images are formed on the intermediate transfer belt 10. After that, the toner images of the four colors borne on the intermediate transfer belt 10 are secondarily transferred in a batch onto the surface of a transfer material P, such as paper or an OHP sheet, fed by a sheet feeding unit 50 in the process of passing through a secondary transfer portion formed by the contact between the secondary transfer roller 15 and the intermediate transfer belt 10. The transfer material P having the toner images of the four colors transferred thereto by the secondary transfer is then heated and pressurized in a fixing unit 30, and the toners of the four colors are melted and mixed to be fixed onto the transfer material P. The toner remaining on the intermediate transfer belt 10 after the secondary transfer is cleaned and removed by a belt cleaning unit 17 arranged so as to face the counter roller 13 through intermediation of the intermediate transfer belt 10.

The electrophotographic photosensitive member of the present invention may be used in, for example, a laser beam printer, an LED printer, or a copying machine.

According to the present invention, the electrophotographic photosensitive member, which suppresses initial image smearing and has improved transferability while having improved injection chargeability, can be provided.

### EXAMPLES

The present invention is described in more detail below by way of Examples and Comparative Examples. The present invention is by no means limited to the following Examples without departing from the gist of the present invention. In the following Examples, “part(s)” is by mass unless otherwise specified.

The thicknesses of the respective layers of each of the electrophotographic photosensitive members of Examples and Comparative Examples except a charge-generating layer and a surface layer were determined by a method including using an eddy current-type thickness meter (FISCHERSCOPE, manufactured by Fischer Instruments K.K.), or a method including converting the mass of the layer per unit area into a specific gravity. The thickness of the charge-generating layer was measured by converting the Macbeth density value of the photosensitive member with a calibration curve obtained in advance from: a Macbeth density value measured by pressing a spectral densitometer (product name: X-Rite 504/508, manufactured by X-Rite, Inc.) against the surface of the photosensitive member; and the value of the thickness of the layer measured through the observation of a sectional SEM image thereof.

<Preparation of Coating Liquid 1 for Electroconductive Layer>

Anatase-type titanium oxide having an average primary particle diameter of 200 nm was used as a substrate, and a sulfuric acid solution of titanium and niobium containing 33.7 parts of titanium in terms of TiO₂ and 2.9 parts of niobium in terms of Nb₂O₅ was prepared. 100 Parts of the substrate was dispersed in pure water to provide 1,000 parts of a suspension, and the suspension was warmed to 60° C. The sulfuric acid solution of titanium and niobium, and 10 mol/L sodium hydroxide were dropped over 3 hours so that the pH of the suspension became from 2 to 3. After the dropping of the total amounts of the solutions, the pH was adjusted to the vicinity of a neutral value, and a polyacrylamide-based aggregating agent was added to precipitate a solid content. The supernatant was removed, and the residue was filtered and washed, followed by drying at 110° C. Thus, an intermediate containing 0.1 wt % of organic matter derived from the aggregating agent in terms of C was obtained.

The intermediate was fired in nitrogen at 750° C. for 1 hour, and was then fired in air at 450° C. to produce titanium oxide particles 1. The average primary particle diameter of the resultant particles measured by the above-mentioned method of measuring a particle diameter with a scanning electron microscope was 220 nm.

Subsequently, 50 parts of a phenol resin (monomer/oligomer of a phenol resin) (product name: PLYOPHEN J-325, manufactured by DIC Corporation, resin solid content: 60%, density after curing: 1.3 g/cm²) serving as a binding material was dissolved in 35 parts of 1-methoxy-2-propanol serving as a solvent to provide a solution.

60 Parts of the titanium oxide particles 1 were added to the solution, and the mixture was loaded into a vertical sand mill using 120 parts of glass beads having a number-average primary particle diameter of 1.0 mm as a dispersion medium, and was subjected to dispersion treatment for 4 hours under the conditions of a dispersion liquid temperature of 23° C.±3° C. and a number of revolutions of 1,500 rpm (peripheral speed: 5.5 m/s). Thus, a dispersion liquid was obtained. The glass beads were removed from the dispersion liquid with a mesh. 0.01 Part of a silicone oil (product name: SH28 PAINT ADDITIVE, manufactured by Dow Corning Toray Co., Ltd.) serving as a leveling agent and 8 parts of silicone resin particles (product name: KMP-590, manufactured by Shin-Etsu Chemical Co., Ltd., average primary particle diameter: 2 density: 1.3 g/cm³) serving as a surface roughness-imparting material were added to the dispersion liquid after the removal of the glass beads, and the mixture was stirred, followed by filtration with PTFE filter paper (product name: PF-060, manufactured by Advantec Toyo Kaisha, Ltd.) under pressure. Thus, a coating liquid 1 for an electroconductive layer was prepared.

<Preparation of Coating Liquid 1 for Undercoat Layer>

100 Parts of rutile-type titanium oxide particles (average primary particle diameter: 50 nm, manufactured by Tayca Corporation) were stirred and mixed with 500 parts of toluene, and 3.5 parts of vinyltrimethoxysilane (product name: KBM-1003, manufactured by Shin-Etsu Chemical Co., Ltd.) was added to the mixture, followed by dispersion treatment in a vertical sand mill using glass beads each having a diameter of 1.0 mm for 8 hours. After the glass beads had been removed, toluene was evaporated by distillation under reduced pressure, and the residue was dried for 3 hours at 120° C. to provide rutile-type titanium oxide particles whose surfaces had already been treated with an organosilicon compound. When the volume of the resultant titanium oxide particles was represented by “a”, and the average primary particle diameter of the titanium oxide particles was represented by “b” [μm], the ratio “a/b” was 15.6. The value of the “a” was determined from a microscopic image obtained by observing a section of an electrophotographic photosensitive member with a field emission scanning electron microscope (FE-SEM, product name: S-4800, manufactured by Hitachi High-Technologies Corporation) after the production of the electrophotographic photosensitive member.

18.0 Parts of the rutile-type titanium oxide particles whose surfaces had already been treated with the organosilicon compound, 4.5 parts of N-methoxymethylated nylon (product name: TORESIN EF-30T, manufactured by Nagase ChemteX Corporation), and 1.5 parts of a copolymerized nylon resin (product name: AMILAN CM8000, manufactured by Toray Industries, Inc.) were added to a mixed solvent of 90 parts of methanol and 60 parts of 1-butanol to prepare a dispersion liquid.

The dispersion liquid was subjected to dispersion treatment in a vertical sand mill using glass beads each having a diameter of 1.0 mm for 5 hours, and the glass beads were removed. Thus, a coating liquid 1 for an undercoat layer was prepared.

### Synthesis of Phthalocyanine Pigment

### Synthesis Example 1

Under a nitrogen flow atmosphere, 5.46 parts of orthophthalonitrile and 45 parts of α-chloronaphthalene were loaded into a reaction kettle. After that, the mixture was heated so that its temperature was increased to 30° C., followed by the maintenance of the temperature. Next, 3.8 parts of gallium trichloride was loaded into the mixture at the temperature (30° C.). The moisture concentration of the mixed liquid at the time of the loading was 150 ppm. After that, the temperature of the mixed liquid was increased to 200° C. Next, under a nitrogen flow atmosphere, the mixed liquid was subjected to a reaction at a temperature of 200° C. for 4.5 hours, and was then cooled. The product was filtered when its temperature reached 150° C. The resultant filter residue was subjected to dispersion washing with N,N-dimethylformamide at a temperature of 140° C. for 2 hours, and was then filtered. The resultant filter residue was washed with methanol, and was then dried to provide a chlorogallium phthalocyanine pigment in a yield of 71%.

### Synthesis Example 2

4.65 Parts of the chlorogallium phthalocyanine pigment obtained in Synthesis Example 1 described above was dissolved in 139.5 parts of concentrated sulfuric acid at a temperature of 10° C., and the solution was dropped into 620 parts of ice water under stirring so that the pigment was reprecipitated, followed by filtration with a filter press under reduced pressure. At this time, No. 5C (manufactured by Advantec Toyo Kaisha, Ltd.) was used as a filter. The resultant wet cake (filter residue) was subjected to dispersion washing with 2% ammonia water for 30 minutes, and was then filtered with the filter press. Next, the resultant wet cake (filter residue) was subjected to dispersion washing with ion-exchanged water, and then its filtration with the filter press was repeated three times. Finally, the filter residue was freeze-dried to provide a hydroxygallium phthalocyanine pigment (hydrous hydroxygallium phthalocyanine pigment) having a solid content of 23% in a yield of 97%.

### Synthesis Example 3

6.6 Kilograms of the hydroxygallium phthalocyanine pigment obtained in Synthesis Example 2 described above was dried with a hyper-dry dryer (product name: HD-06R, frequency (oscillatory frequency): 2,455 MHz±15 MHz, manufactured by Biocon (Japan) Ltd.) as described below.

The above-mentioned hydroxygallium phthalocyanine pigment was mounted on a dedicated circular plastic tray under a block state (hydrous cake thickness: 4 cm or less) without being treated after its removal from the filter press, and the dryer was set as follows: a far-infrared ray was turned off, and the temperature of the inner wall of the dryer was set to 50° C. Then, at the time of microwave application, a vacuum pump and a leak valve were adjusted to adjust a vacuum degree in the dryer to from 4.0 kPa to kPa.

First, as a first step, a microwave having an output of 4.8 kW was applied to the hydroxygallium phthalocyanine pigment for 50 minutes. Next, the microwave was turned off once, and the leak valve was closed once to establish a high vacuum of 2 kPa or less. The solid content of the hydroxygallium phthalocyanine pigment at this time point was 88%. As a second step, the leak valve was adjusted to adjust the vacuum degree (pressure in the dryer) within the above-mentioned preset value range (from 4.0 kPa to 10.0 kPa). After that, a microwave having an output of 1.2 kW was applied to the hydroxygallium phthalocyanine pigment for 5 minutes. In addition, the microwave was turned off once, and the leak valve was closed once to establish a high vacuum of 2 kPa or less. The second step was further repeated once (a total of twice). The solid content of the hydroxygallium phthalocyanine pigment at this time point was 98%. Further, as a third step, microwave application was performed in the same manner as in the second step except that the output of the microwave in the second step was changed from 1.2 kW to 0.8 kW. The third step was further repeated once (a total of twice). Further, as a fourth step, the leak valve was adjusted to return the vacuum degree (pressure in the dryer) within the above-mentioned preset value range (from 4.0 kPa to 10.0 kPa). After that, a microwave having an output of 0.4 kW was applied to the hydroxygallium phthalocyanine pigment for 3 minutes. In addition, the microwave was turned off once, and the leak valve was closed once to establish a high vacuum of 2 kPa or less. The fourth step was further repeated seven times (a total of eight times). Thus, 1.52 kg of a hydroxygallium phthalocyanine pigment (crystal) having a water content of 1% or less was obtained in a total of 3 hours.

### Synthesis Example 4

50 Grams of o-phthalodinitrile and 20 g of titanium tetrachloride were stirred in 1,000 g of α-chloronaphthalene under heating at 200° C. for 3 hours. After that, the solution was cooled to 50° C., and a precipitated crystal was separated by filtration. Thus, a paste of dichlorotitanium phthalocyanine was obtained. Next, the paste was washed with 1,000 mL of N,N-dimethylformamide heated to 100° C. under stirring. Next, the washed product was repeatedly washed with 1,000 mL of methanol at 60° C. twice, and was separated by filtration. Further, the resultant paste was stirred in 1,000 mL of deionized water at 80° C. for 1 hour, and was separated by filtration to provide 43 g of a blue titanyl phthalocyanine pigment.

Next, the pigment was dissolved in 300 mL of concentrated sulfuric acid, and the solution was dropped into 3,000 mL of deionized water at 20° C. under stirring so that the pigment was reprecipitated. The mixture was filtered, and the precipitate was sufficiently washed with water. After that, an amorphous titanyl phthalocyanine pigment was obtained. 40 Grams of the amorphous titanyl phthalocyanine pigment was subjected to suspension stirring treatment in 1,000 mL of methanol under room temperature (22° C.) for 8 hours, and was separated by filtration, followed by drying under reduced pressure. Thus, a low-crystalline titanyl phthalocyanine pigment was obtained.

### Synthesis Example 5

Under a nitrogen flow atmosphere, 100 g of gallium trichloride and 291 g of orthophthalonitrile were added to 1,000 mL of α-chloronaphthalene, and the mixture was subjected to a reaction at a temperature of 200° C. for 24 hours, followed by the filtration of the product. The resultant wet cake was stirred in N,N-dimethylformamide under heating at a temperature of 150° C. for 30 minutes, and was then filtered. The resultant filter residue was washed with methanol, and was then dried to provide a chlorogallium phthalocyanine pigment in a yield of 83%.

20 Grams of the chlorogallium phthalocyanine pigment obtained by the above-mentioned method was dissolved in 500 mL of concentrated sulfuric acid, and the solution was stirred for 2 hours. After that, the solution was dropped into a mixed solution of 1,700 mL of distilled water and 660 mL of concentrated ammonia water, which had been cooled with ice, so that the pigment was reprecipitated. The precipitate was sufficiently washed with distilled water, and was dried to provide a hydroxygallium phthalocyanine pigment.

<Preparation of Coating Liquid 1 for Charge-generating Layer>

0.5 Part of the hydroxygallium phthalocyanine pigment obtained in Synthesis Example 5, 7.5 parts of N,N-dimethylformamide (product code: D0722, manufactured by Tokyo Chemical Industry Co., Ltd.), and 29 parts of glass beads each having a diameter of 0.9 mm were subjected to milling treatment with a sand mill (BSG-20, manufactured by AIMEX Co., Ltd.) under a temperature of 25° C. for 24 hours. At this time, the treatment was performed under such a condition that the disc of the sand mill rotated 1,500 times in 1 minute. The liquid thus treated was filtered with a filter (product number: N-NO. 125T, pore diameter: 133 μm, manufactured by NBC Meshtec Inc.) so that the glass beads were removed. 30 Parts of N,N-dimethylformamide was added to the liquid, and then the mixture was filtered, followed by sufficient washing of the filter residue on a filter with n-butyl acetate. Then, the washed filter residue was dried in a vacuum to provide 0.45 part of a hydroxygallium phthalocyanine pigment. The resultant pigment contained N,N-dimethylformamide.

Subsequently, 20 parts of the hydroxygallium phthalocyanine pigment obtained by the milling treatment, 10 parts of polyvinyl butyral (product name: S-LEC BX-1, manufactured by Sekisui Chemical Co., Ltd.), 190 parts of cyclohexanone, and 482 parts of glass beads each having a diameter of 0.9 mm were subjected to dispersion treatment with a sand mill (K-800, manufactured by Igarashi Machine Production Co., Ltd. (currently AIMEX Co., Ltd.), disc diameter: 70 mm, number of discs: 5) under a cooling water temperature of 18° C. for 4 hours. At this time, the treatment was performed under such a condition that the discs each rotated 1,800 times in 1 minute. The glass beads were removed from the dispersion liquid, and 444 parts of cyclohexanone and 634 parts of ethyl acetate were added to the residue to prepare a coating liquid 1 for a charge-generating layer.

<Preparation of Coating Liquid 1 for Charge-transporting Layer>

3.6 Parts of a triarylamine compound represented by the following formula (CTM-1):

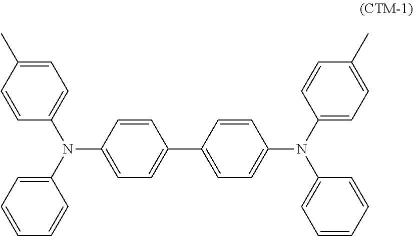 [SMILES: Cc1ccc(N(c2ccccc2)c2ccc(-c3ccc(N(c4ccccc4)c4ccc(C)cc4)cc3)cc2)cc1]

and 5.4 parts of a triarylamine compound represented by the following formula (CTM-2):

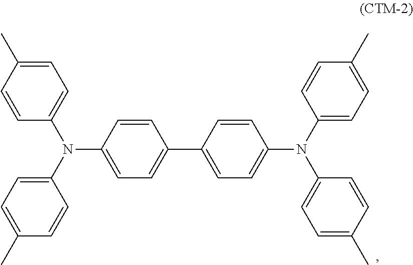 [SMILES: Cc1ccc(N(c2ccc(C)cc2)c2ccc(-c3ccc(N(c4ccc(C)cc4)c4ccc(C)cc4)cc3)cc2)cc1]

which served as charge-transporting materials, and 10 parts of a polycarbonate resin (product name: IUPILON Z-400, manufactured by Mitsubishi Engineering-Plastics Corporation) were dissolved in a mixed solvent of 25 parts of orthoxylene, 25 parts of methyl benzoate, and 25 parts of dimethoxymethane to prepare a coating liquid 1 for a charge-transporting layer.

<Preparation of Coating Liquid 2 for Charge-transporting Layer>

9 Parts of a triphenylamine compound represented by the following formula (CTM-3):

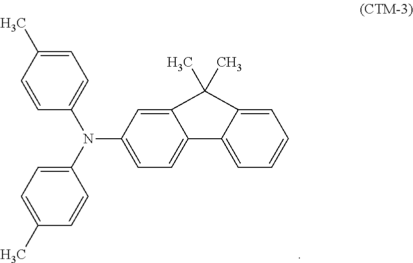 [SMILES: Cc1ccc(N(c2ccc(C)cc2)c2ccc3c(c2)C(C)(C)c2ccccc2-3)cc1]

which served as a charge-transporting material, and 10 parts of a polyarylate resin including a structural unit represented by the following formula (3-1) and a structural unit represented by the following formula (3-2) at a ratio of 5/5, and having a weight-average molecular weight of 100,000 were dissolved in a mixed solvent of 30 parts of dimethoxymethane and 70 parts of chlorobenzene to prepare a coating liquid 2 for a charge-transporting layer.

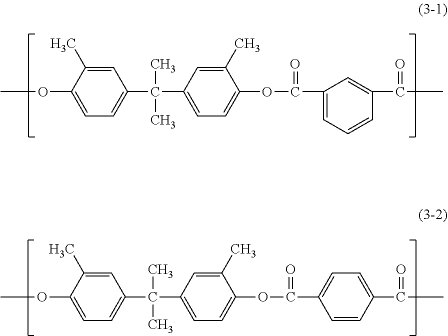

<Production of Anatase-type Titanium Oxide Particles 1 to 10>

Anatase-type titanium oxide particles may be produced by a known sulfuric acid method. In the production of titanium oxide, a solution containing titanium sulfate and titanyl sulfate as titanium compounds is hydrolyzed through heating to produce a hydrous titanium dioxide slurry, and the titanium dioxide slurry is dewatered and fired. Thus, anatase-type titanium oxide having an anatase degree of nearly 100% is obtained.

Anatase-type titanium oxide particles 1 to 10 were each produced by controlling the solution concentration of titanyl sulfate in the above-mentioned method.

### Production Example of Rutile-type Titanium Oxide Particles 1

200 Parts by mass of ultra-fine titanium oxide (TTO-55(A): manufactured by Ishihara Sangyo Kaisha, Ltd.; average primary particle diameter (manufacturer's nominal value): 40 nm) was sealed in a tube made of Teflon (trademark) together with 10,000 parts by mass of an aqueous solution of potassium hydroxide having a concentration of 17 mol/L. The tube was hermetically sealed in a pressure-resistant glass vessel and kept at 110° C. for 20 hours to perform hydrothermal treatment. The reaction product was neutralized with an aqueous solution of hydrochloric acid having a concentration of 1 mol/L, and then washing with ion-exchanged water and centrifugation were repeated to provide a white precipitate. Further, the resultant white precipitate was dried and subsequently subjected to firing treatment at 750° C. for 45 minutes to provide rutile-type titanium oxide particles 1 each having a primary particle diameter of 55 nm.

The rutile-type titanium oxide particles 1 were subjected to X-ray diffraction spectrum (CuKα) measurement using RINT2000 (manufactured by Rigaku Corporation) to find diffraction peaks at 27.4°, 36.1°, 41.2°, and 54.3° attributed to rutile-type titanium oxide.

TABLE 1

| | Average |
|---|---|
| | primary |
| | particle |
| Titanium oxide particles | diameter [nm] |
| Anatase-type titanium oxide particles 1 | 55 |
| Anatase-type titanium oxide particles 2 | 42 |
| Anatase-type titanium oxide particles 3 | 32 |
| Anatase-type titanium oxide particles 4 | 22 |
| Anatase-type titanium oxide particles 5 | 146 |
| Anatase-type titanium oxide particles 6 | 220 |
| Anatase-type titanium oxide particles 7 | 25 |
| Anatase-type titanium oxide particles 8 | 60 |
| Anatase-type titanium oxide particles 9 | 170 |
| Anatase-type titanium oxide particles 10 | 185 |
| Rutile-type titanium oxide particles 1 | 55 |

<Production of Electroconductive Particles 1>

Niobium(V) hydroxide was dissolved in concentrated sulfuric acid, and the solution was mixed with an aqueous solution of titanium sulfate to prepare an acidic mixed liquid of a niobium salt and a titanium salt (hereinafter referred to as “titanium-niobium mixed liquid”).

The anatase-type titanium oxide particles 1 were dispersed as core particles in water to provide a suspension, and the suspension was heated to 70° C. while being stirred.

While the pH of the suspension was maintained at 2.5, the titanium-niobium mixed liquid having a content of 337 g/kg in terms of Ti and a content of 21 g/kg in terms of Nb, and an aqueous solution of sodium hydroxide were simultaneously added with respect to the weight of the anatase-type titanium oxide particles 1.

After the completion of the dropwise addition, the suspension was filtered, washed, and dried at 110° C. for 8 hours. The dried product was fired in an air atmosphere at 710° C. for 1 hour to provide electroconductive particles each having a niobium atom localized in the vicinity of its surface. 100.0 Parts of the electroconductive particles were mixed with 6.0 parts of a compound represented by the following formula (S-1) (product name: trimethoxypropylsilane, manufactured by Tokyo Chemical Industry Co., Ltd.) and 200 parts of toluene, and the mixture was stirred with a stirring device for 4 hours. After that, the mixture was filtered and washed, and was then further subjected to heating treatment at 120° C. for 3 hours. Thus, electroconductive particles 1 having an average particle diameter of 65 nm were obtained. The volume resistivity of the resultant electroconductive particles was measured to be 1.4×10⁵ Ω·cm.

The resultant electroconductive particles 1 were observed with a transmission electron microscope (JEM-2800, manufactured by JEOL Ltd.), and a niobium atom-to-titanium atom ratio at the central portion of each of the particles and that at an inside portion at 5% of the particle diameter of the particle from the surface of the particle were measured with an EDS (NORAN SYSTEM 7, manufactured by Thermo Fisher Scientific, Inc.). The observation was performed on 10 particles in each sliced sample, and their measured values were averaged. The niobium atom-to-titanium atom ratio at the central portion of the particle and that at the inside portion at 5% of the particle diameter from the surface of the particle thus obtained were represented by α1 and α2, respectively. The ratio “α2/α1” was defined as a niobium localization ratio, and its value was calculated to be 7.7. The measurement with the EDS is performed under the conditions of an acceleration voltage of 200 kV and a beam diameter of 1.0 nm.

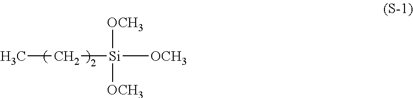

<Production of Electroconductive Particles 2 to 5>

Electroconductive particles 2 to 5 were each produced in the same manner as in the production of the electroconductive particles 1 except that in the production of the electroconductive particles 1, the kind of the core particles to be used and the niobium atom-to-titanium atom weight ratio in the titanium-niobium mixed liquid with respect to the core were changed as shown in Table 2. The average particle diameters, volume resistivities, and niobium localization ratios of the resultant electroconductive particles 2 to 5 are shown in Table 2.

<Production of Electroconductive Particles 6>

300 Grams of the anatase-type titanium oxide particles 1 were dispersed in 3 liters of water to provide an aqueous suspension. The suspension was warmed to and held at A solution obtained by dissolving 160.5 g of stannic chloride (containing 98 wt % of SnCl₄·5H₂O) in 1.5 liters of 2 N hydrochloric acid, and 12 wt % ammonia water were separately prepared, and were simultaneously dropped over about 2 hours so that the pH of the suspension was held at from 7 to 8. Further, an aqueous solution obtained by dissolving 1.1 g of orthophosphoric acid in 10 milliliters of water was added to the mixture, and then the whole was stirred for 30 minutes so that the surfaces of the titanium dioxide particles were each covered with a hydrous product of tin oxide containing phosphorus. The treated suspension was filtered and washed, and the resultant treated titanium dioxide cake was dried at 110° C. Next, the resultant dry powder was fired in a stream of a nitrogen gas (3 liters/min) at 630° C. for 1 hour to provide electroconductive particles 6. The average particle diameter, volume resistivity, and niobium localization ratio of the resultant electroconductive particles 6 are shown in Table 2.

<Production of Electroconductive Particles 7 to 12>

Electroconductive particles 7 to 12 were each produced in the same manner as in the production of the electroconductive particles 1 except that in the production of the electroconductive particles 1, the kind of the core particles to be used and the niobium atom-to-titanium atom weight ratio in the titanium-niobium mixed liquid with respect to the core were changed as shown in Table 2. The average particle diameters, volume resistivities, and niobium localization ratios of the resultant electroconductive particles 7 to 12 are shown in Table 2.

TABLE 2

| | Core particles | | | | | | | |
|---|---|---|---|---|---|---|---|---|
| | | Average | Niobium/titanium | | | Average primary | | |
| | | primary | mass ratio in | | | particle diameter | Volume | Niobium |
| | | particle | titanium-niobium | Covering layer | | D2 of | resistivity | localization |
| | | diameter | mixed liquid with | | Thickness | electroconductive | R2 | ratio |
| | Kind | [nm] | respect to core | Kind | [nm] | particles [nm] | [Ω · cm] | [—] |
| Electroconductive | Anatase-type | 55 | 21/337 | Niobium-doped | 5 | 65 | 1.4 × 105 | 7.7 |
| particles 1 | titanium oxide | | | titanium oxide | | | | |
| | particles 1 | | | | | | | |
| Electroconductive | Anatase-type | 42 | 16/342 | Niobium-doped | 4 | 50 | 2.5 × 106 | 7.0 |
| particles 2 | titanium oxide | | | titanium oxide | | | | |
| | particles 2 | | | | | | | |
| Electroconductive | Anatase-type | 32 | 12/346 | Niobium-doped | 4 | 40 | 2.2 × 107 | 5.5 |
| particles 3 | titanium oxide | | | titanium oxide | | | | |
| | particles 3 | | | | | | | |
| Electroconductive | Anatase-type | 22 | 14/344 | Niobium-doped | 4 | 30 | 7.2 × 106 | 6.1 |
| particles 4 | titanium oxide | | | titanium oxide | | | | |
| | particles 4 | | | | | | | |
| Electroconductive | Anatase-type | 146 | 12/346 | Niobium-doped | 12 | 170 | 2.6 × 107 | 5.6 |
| particles 5 | titanium oxide | | | titanium oxide | | | | |
| | particles 5 | | | | | | | |
| Electroconductive | Anatase-type | 55 | | Tin oxide | 5 | 65 | 1.9 × 103 | 0.0 |
| particles 6 | titanium oxide | | | | | | | |
| | particles 1 | | | | | | | |
| Electroconductive | Anatase-type | 55 | 9/349 | Niobium-doped | 5 | 65 | 1.0 × 108 | 4.2 |
| particles 7 | titanium oxide | | | titanium oxide | | | | |
| | particles 1 | | | | | | | |
| Electroconductive | Anatase-type | 220 | 12/346 | Niobium-doped | 25 | 270 | 1.0 × 107 | 5.8 |
| particles 8 | titanium oxide | | | titanium oxide | | | | |
| | particles 6 | | | | | | | |
| Electroconductive | Anatase-type | 25 | 12/346 | Niobium-doped | 2.5 | 30 | 1.9 × 107 | 5.4 |
| particles 9 | titanium oxide | | | titanium oxide | | | | |
| | particles 7 | | | | | | | |
| Electroconductive | Anatase-type | 60 | 13/370 | Niobium-doped | 10 | 80 | 2.4 × 107 | 5.7 |
| particles 10 | titanium oxide | | | titanium oxide | | | | |
| | particles 8 | | | | | | | |
| Electroconductive | Anatase-type | 55 | 4/354 | Niobium-doped | 10 | 65 | 5.5 × 109 | 2.0 |
| particles 11 | titanium oxide | | | titanium oxide | | | | |
| | particles 1 | | | | | | | |
| Electroconductive | Rutile-type | 55 | 21/337 | Niobium-doped | 5 | 65 | 1.4 × 105 | 7.7 |
| particles 12 | titanium oxide | | | titanium oxide | | | | |
| | particles 1 | | | | | | | |

<Production of Insulating Particles 1 to 5 and Insulating Particles 8 to 11>

Parts of a material shown in the column “Insulating particles 1” of Table 3 was added to 10 parts of methanol, and was dispersed therein with a US homogenizer at room temperature for 30 minutes. Next, 0.25 part of n-propyltrimethoxysilane (“KBM-3033”, manufactured by Shin-Etsu Chemical Co., Ltd.) serving as a reactive surface treatment agent and 10 parts of toluene were added to the dispersed product, and the mixture was stirred at room temperature for 60 minutes. The solvent was removed with an evaporator, and then the residue was heated at 140° C. for 60 minutes to produce insulating particles 1 having surfaces treated with the reactive surface treatment agent. Insulating particles 2 to 5 and insulating particles 8 to 11 were each produced in the same manner as in the production of the resultant insulating particles 1. The average primary particle diameters, volume resistivities R1, and average circularities of the resultant insulating particles 1 to and insulating particles 8 to 11 are shown in Table 3.

<Production of Insulating Particles 6 and 7, and Insulating Particles 12>

Insulating particles 6 and 7, and insulating particles 12 were each produced in the same manner as in the production of the electroconductive particles 1 except that in the production of the electroconductive particles 1, the kind of the core particles to be used and the niobium atom-to-titanium atom weight ratio in the titanium-niobium mixed liquid with respect to the core were changed as shown in Table 3. The niobium/titanium weight ratios in the titanium-niobium mixed liquids with respect to the cores, and the average primary particle diameters, volume resistivities R1, and average circularities of the resultant insulating particles 6 and 7, and insulating particles 12 are shown in Table 3.

TABLE 3

| | | | | Average | | |
|---|---|---|---|---|---|---|
| | | | Niobium/titanium | primary | | |
| | | | mass ratio in | particle | Volume | |
| | | | titanium-niobium | diameter D1 | resistivity | Average |
| | | | mixed liquid with | of insulating | R2 | circularity |
| | Kind | Manufacturer | respect to core | particles [nm] | [Ω · cm] | [—] |
| Insulating | QSG-170 | Shin-Etsu Chemical Co., | — | 170 | 1.0 × 1015 | 0.99 |
| particles 1 | | Ltd. | | | | |
| Insulating | KE-P10 | Nippon Shokubai Co., | — | 100 | 1.0 × 1015 | 0.99 |
| particles 2 | | Ltd. | | | | |
| Insulating | QSG-80 | Shin-Etsu Chemical Co., | — | 80 | 1.0 × 1015 | 0.99 |
| particles 3 | | Ltd. | | | | |
| Insulating | KE-P30 | Nippon Shokubai Co., | — | 300 | 1.0 × 1015 | 0.99 |
| particles 4 | | Ltd. | | | | |
| Insulating | Anatase-type titanium | — | — | 170 | 1.2 × 1013 | 0.9 |
| particles 5 | oxide particles 9 | | | | | |
| Insulating | Anatase-type titanium | — | 0.5/170 | 185 | 2.0 × 1012 | 0.86 |
| particles 6 | oxide particles 9 | | | | | |
| Insulating | Anatase-type titanium | — | 2/356 | 170 | 1.0 × 1010 | 0.83 |
| particles 7 | oxide particles 5 | | | | | |
| Insulating | sicastar (trademark) | micromod | — | 200 | 1.0 × 1015 | 0.99 |
| particles 8 | 200 nm | | | | | |
| Insulating | sicastar (trademark) 50 | micromod | — | 50 | 1.0 × 1015 | 0.99 |
| particles 9 | nm | | | | | |
| Insulating | Anatase-type titanium | — | — | 60 | 3.5 × 1013 | 0.89 |
| particles 10 | oxide particles 8 | | | | | |
| Insulating | Anatase-type titanium | — | — | 55 | 4.0 × 1013 | 0.89 |
| particles 11 | oxide particles 1 | | | | | |
| Insulating | Anatase-type titanium | — | 0.5/170 | 200 | 1.8 × 1012 | 0.86 |
| particles 12 | oxide particles 10 | | | | | |

<Preparation of Coating Liquid 1 for Surface Layer>
Silica particles each having a particle diameter of 170 nm serving as insulating particles (“QSG-170”, manufactured by Shin-Etsu Chemical Co., Ltd.): 3.7 parts
Electroconductive particles 1 serving as electroconductive particles: 8.3 parts
Compound represented by the following formula (O-1) serving as binder resin: 8.0 parts
1-Propanol: 40.0 parts
Cyclohexane: 40.0 parts
   Those materials were mixed and stirred with a stirring device for 6 hours to prepare a coating liquid 1 for a surface layer.

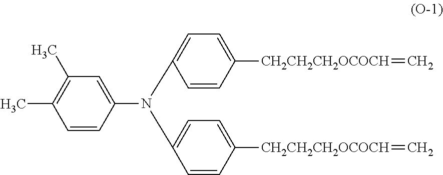

<Preparation of Coating Liquids 2 to 49 for Surface Layers>

Coating liquids 2 to 49 for surface layers were each prepared in the same manner as in the preparation of the coating liquid 1 for a surface layer except that the kinds and loading amounts of the insulating particles, the electroconductive particles, and the binder resin were changed as shown in Table 4.

TABLE 4

| | Insulating particles | | | | Electroconductive particles | | | | | |
|---|---|---|---|---|---|---|---|---|---|---|
| | | Average | | | | Average | | | | |
| | | primary | | | | primary | | | | |
| | | particle | Loading | Average | | particle | Loading | Average | Binder | Loading |
| | | diameter | amount | circularity | | diameter | amount | circularity | resin | amount |
| | Kind | D1 [nm] | [part(s)] | [—] | Kind | D1 [nm] | [part(s)] | [—] | Kind | [part(s)] |
| Coating liquid 1 for | Insulating | 170 | 3.7 | 0.99 | Electroconductive | 65 | 8.3 | 7.7 | (O-1) | 8.0 |
| surface layer | particles 1 | | | | particles 1 | | | | | |
| Coating liquid 2 for | Insulating | 170 | 9.9 | 0.99 | Electroconductive | 65 | 4.4 | 7.7 | (O-1) | 5.7 |
| surface layer | particles 1 | | | | particles 1 | | | | | |
| Coating liquid 3 for | Insulating | 170 | 8.3 | 0.99 | Electroconductive | 65 | 3.7 | 7.7 | (O-1) | 8.0 |
| surface layer | particles 1 | | | | particles 1 | | | | | |
| Coating liquid 4 for | Insulating | 170 | 6.9 | 0.99 | Electroconductive | 65 | 5.1 | 7.7 | (O-1) | 8.0 |
| surface layer | particles 1 | | | | particles 1 | | | | | |
| Coating liquid 5 for | Insulating | 170 | 5.7 | 0.99 | Electroconductive | 65 | 4.3 | 7.7 | (O-1) | 10.0 |
| surface layer | particles 1 | | | | particles 1 | | | | | |
| Coating liquid 6 for | Insulating | 170 | 3.7 | 0.99 | Electroconductive | 65 | 8.3 | 7.7 | (O-2) | 8.0 |
| surface layer | particles 1 | | | | particles 1 | | | | | |
| Coating liquid 7 for | Insulating | 170 | 1.6 | 0.99 | Electroconductive | 65 | 10.4 | 7.7 | (O-1) | 8.0 |
| surface layer | particles 1 | | | | particles 1 | | | | | |
| Coating liquid 8 for | Insulating | 100 | 8.3 | 0.99 | Electroconductive | 65 | 3.7 | 7.7 | (O-2) | 8.0 |
| surface layer | particles 2 | | | | particles 1 | | | | | |
| Coating liquid 9 for | Insulating | 100 | 3.7 | 0.99 | Electroconductive | 65 | 8.3 | 7.7 | (O-2) | 8.0 |
| surface layer | particles 2 | | | | particles 1 | | | | | |
| Coating liquid 10 for | Insulating | 100 | 3.7 | 0.99 | Electroconductive | 50 | 8.3 | 7.0 | (O-1) | 8.0 |
| surface layer | particles 2 | | | | particles 2 | | | | | |
| Coating liquid 11 for | Insulating | 100 | 3.7 | 0.99 | Electroconductive | 40 | 8.3 | 5.5 | (O-1) | 8.0 |
| surface layer | particles 2 | | | | particles 3 | | | | | |
| Coating liquid 12 for | Insulating | 80 | 3.7 | 0.99 | Electroconductive | 65 | 8.3 | 7.7 | (O-1) | 8.0 |
| surface layer | particles 3 | | | | particles 1 | | | | | |
| Coating liquid 13 for | Insulating | 80 | 3.7 | 0.99 | Electroconductive | 30 | 8.3 | 6.1 | (O-1) | 8.0 |
| surface layer | particles 3 | | | | particles 4 | | | | | |
| Coating liquid 14 for | Insulating | 300 | 3.7 | 0.99 | Electroconductive | 170 | 8.3 | 5.6 | (O-1) | 8.0 |
| surface layer | particles 4 | | | | particles 5 | | | | | |
| Coating liquid 15 for | Insulating | 300 | 9.5 | 0.99 | Electroconductive | 170 | 3.2 | 5.6 | (O-1) | 7.3 |
| surface layer | particles 4 | | | | particles 5 | | | | | |
| Coating liquid 16 for | Insulating | 100 | 10.2 | 0.99 | Electroconductive | 65 | 4.1 | 7.7 | (O-1) | 5.7 |
| surface layer | particles 2 | | | | particles 1 | | | | | |
| Coating liquid 17 for | Insulating | 170 | 1.1 | 0.99 | Electroconductive | 65 | 2.5 | 7.7 | (O-1) | 1.4 |
| surface layer | particles 1 | | | | particles 1 | | | | | |
| Coating liquid 18 for | Insulating | 170 | 0.9 | 0.99 | Electroconductive | 65 | 2.1 | 7.7 | (O-1) | 2.0 |
| surface layer | particles 1 | | | | particles 1 | | | | | |
| Coating liquid 19 for | Insulating | 170 | 0.8 | 0.99 | Electroconductive | 65 | 1.7 | 7.7 | (O-1) | 2.5 |
| surface layer | particles 1 | | | | particles 1 | | | | | |
| Coating liquid 20 for | Insulating | 100 | 1.1 | 0.99 | Electroconductive | 65 | 2.5 | 7.7 | (O-1) | 1.4 |
| surface layer | particles 2 | | | | particles 1 | | | | | |
| Coating liquid 21 for | Insulating | 100 | 0.9 | 0.99 | Electroconductive | 65 | 2.1 | 7.7 | (O-1) | 2.0 |
| surface layer | particles 2 | | | | particles 1 | | | | | |
| Coating liquid 22 for | Insulating | 80 | 0.9 | 0.99 | Electroconductive | 65 | 2.1 | 7.7 | (O-1) | 2.0 |
| surface layer | particles 3 | | | | particles 1 | | | | | |
| Coating liquid 23 for | Insulating | 170 | 3.7 | 0.90 | Electroconductive | 65 | 8.3 | 7.7 | (O-1) | 8.0 |
| surface layer | particles 5 | | | | particles 1 | | | | | |
| Coating liquid 24 for | Insulating | 185 | 6.0 | 0.86 | Electroconductive | 65 | 6.0 | 7.7 | (O-1) | 8.0 |
| surface layer | particles 6 | | | | particles 1 | | | | | |
| Coating liquid 25 for | Insulating | 170 | 3.7 | 0.99 | Electroconductive | 65 | 8.3 | — | (O-1) | 8.0 |
| surface layer | particles 1 | | | | particles 6 | | | | | |
| Coating liquid 26 for | Insulating | 170 | 3.7 | 0.99 | Electroconductive | 65 | 8.3 | 7.7 | (O-1) | 8.0 |
| surface layer | particles 1 | | | | particles 1 | | | | | |
| Coating liquid 27 for | Insulating | 170 | 3.7 | 0.83 | Electroconductive | 65 | 8.3 | 7.7 | (O-1) | 8.0 |
| surface layer | particles 7 | | | | particles 1 | | | | | |
| Coating liquid 28 for | Insulating | 170 | 3.7 | 0.99 | Electroconductive | 65 | 8.3 | 4.2 | (O-1) | 8.0 |
| surface layer | particles 1 | | | | particles 7 | | | | | |
| Coating liquid 29 for | Insulating | 300 | 2.7 | 0.99 | Electroconductive | 270 | 6.0 | 5.8 | (O-1) | 8.8 |
| surface layer | particles 4 | | | | particles 8 | | | | | |
| Coating liquid 30 for | Insulating | 200 | 2.2 | 0.99 | Electroconductive | 170 | 5.0 | 5.6 | (O-1) | 10.3 |
| surface layer | particles 8 | | | | particles 5 | | | | | |
| Coating liquid 31 for | Insulating | 50 | 0.9 | 0.99 | Electroconductive | 30 | 2.1 | 5.4 | (O-1) | 2.0 |
| surface layer | particles 9 | | | | particles 9 | | | | | |
| Coating liquid 32 for | Insulating | 170 | 3.7 | 0.99 | Electroconductive | 80 | 8.3 | 5.7 | (O-1) | 8.0 |
| surface layer | particles 1 | | | | particles 10 | | | | | |
| Coating liquid 33 for | Insulating | 60 | 0.6 | 0.89 | Electroconductive | 30 | 1.4 | 5.4 | (O-1) | 2.9 |
| surface layer | particles 10 | | | | particles 9 | | | | | |
| Coating liquid 34 for | Insulating | 185 | 0.3 | 0.86 | Electroconductive | 80 | 0.6 | 5.7 | (O-1) | 2.0 |
| surface layer | particles 6 | | | | particles 10 | | | | | |
| Coating liquid 35 for | Insulating | 60 | 3.7 | 0.89 | Electroconductive | 30 | 8.3 | 5.4 | (O-1) | 8.0 |
| surface layer | particles 10 | | | | particles 9 | | | | | |
| Coating liquid 36 for | Insulating | 200 | 2.1 | 0.99 | Electroconductive | 170 | 4.6 | 5.6 | (O-1) | 10.8 |
| surface layer | particles 8 | | | | particles 5 | | | | | |
| Coating liquid 37 for | Insulating | 60 | 0.6 | 0.89 | Electroconductive | 30 | 1.3 | 5.4 | (O-1) | 3.1 |
| surface layer | particles 10 | | | | particles 9 | | | | | |
| Coating liquid 38 for | Insulating | 55 | 0.6 | 0.89 | Electroconductive | 30 | 1.4 | 5.4 | (O-1) | 2.9 |
| surface layer | particles 11 | | | | particles 9 | | | | | |
| Coating liquid 39 for | Insulating | 185 | 1.3 | 0.86 | Electroconductive | 65 | 8.7 | 7.7 | (O-1) | 10.0 |
| surface layer | particles 6 | | | | particles 1 | | | | | |
| Coating liquid 40 for | Insulating | 200 | 1.3 | 0.86 | Electroconductive | 65 | 8.7 | 7.7 | (O-1) | 10.0 |
| surface layer | particles 12 | | | | particles 1 | | | | | |
| Coating liquid 41 for | Insulating | 100 | 10.7 | 0.99 | Electroconductive | 80 | 4.3 | 5.7 | (O-1) | 5.0 |
| surface layer | particles 2 | | | | particles 10 | | | | | |
| Coating liquid 42 for | Insulating | 170 | 20.1 | 0.99 | Electroconductive | 65 | 8.3 | 7.7 | (O-1) | 8.0 |
| surface layer | particles 1 | | | | particles 12 | | | | | |
| Coating liquid 43 for | Insulating | 170 | 1.3 | 0.99 | Electroconductive | 170 | 8.7 | 5.6 | (O-1) | 10.0 |
| surface layer | particles 1 | | | | particles 5 | | | | | |
| Coating liquid 44 for | Insulating | 300 | 1.7 | 0.99 | Electroconductive | 80 | 11.6 | 5.7 | (O-1) | 6.7 |
| surface layer | particles 4 | | | | particles 10 | | | | | |
| Coating liquid 45 for | Insulating | 80 | 10.2 | 0.99 | Electroconductive | 80 | 4.1 | 5.7 | (O-1) | 5.7 |
| surface layer | particles 3 | | | | particles 10 | | | | | |
| Coating liquid 46 for | Insulating | 170 | 13.9 | 0.99 | Electroconductive | 65 | 2.1 | 7.7 | (O-1) | 4.0 |
| surface layer | particles 1 | | | | particles 1 | | | | | |
| Coating liquid 47 for | Insulating | 100 | 1.3 | 0.99 | Electroconductive | 170 | 8.7 | 5.6 | (O-1) | 10.0 |
| surface layer | particles 2 | | | | particles 5 | | | | | |
| Coating liquid 48 for | Insulating | 170 | 3.1 | 0.99 | Electroconductive | 65 | 6.9 | 2.0 | (O-1) | 10.0 |
| surface layer | particles 1 | | | | particles 11 | | | | | |
| Coating liquid 49 for | Insulating | 65 | 3.1 | 0.82 | Electroconductive | 30 | 6.9 | 6.1 | (O-1) | 10.0 |
| surface layer | particles 11 | | | | particles 4 | | | | | |

A compound shown as “(O-2)” in Table 4 is represented by the following formula (O-2).

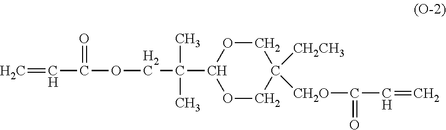

<Production of Electrophotographic Photosensitive Member>

A support, an electroconductive layer, an undercoat layer, a charge-generating layer, a charge-transporting layer, and a surface layer were produced by the following methods.

[Electrophotographic Photosensitive Member 1]

<Support>

An aluminum cylinder having a diameter of 24 mm and a length of 257 mm was used as a support (cylindrical support).

<Electroconductive Layer>

The coating liquid 1 for an electroconductive layer was applied onto the above-mentioned support by dip coating to form a coat, and the coat was heated at 150° C. for 30 minutes to be cured. Thus, an electroconductive layer having a thickness of 22 μm was formed.

<Undercoat Layer>

The coating liquid 1 for an undercoat layer was applied onto the above-mentioned electroconductive layer by dip coating to form a coat, and the coat was heated at 100° C. for 10 minutes to be cured. Thus, an undercoat layer having a thickness of 1.8 μm was formed.

<Charge-Generating Layer>

The coating liquid 1 for a charge-generating layer was applied onto the above-mentioned undercoat layer by dip coating to form a coat, and the coat was dried by heating at a temperature of 100° C. for 10 minutes. Thus, a charge-generating layer having a thickness of 0.20 μm was formed.

<Charge-Transporting Layer>

The coating liquid 1 for a charge-transporting layer was applied onto the above-mentioned charge-generating layer by dip coating to form a coat, and the coat was dried by heating at a temperature of 120° C. for 30 minutes. Thus, a charge-transporting layer having a thickness of 21 μm was formed.

<Surface Layer>

The coating liquid 1 for a surface layer was applied onto the above-mentioned charge-transporting layer by dip coating to form a coat, and the coat was warmed at a temperature of 50° C. for 5 minutes. After that, under a nitrogen atmosphere, the coat was irradiated with electron beams for 2.0 seconds under the conditions of an acceleration voltage of 65 kV and a beam current of 5.0 mA while the support (irradiation target) was rotated at a speed of 300 rpm. The dose of the electron beams was 15 kGy. After that, under the nitrogen atmosphere, the temperature of the coat was increased to 120° C. The oxygen concentration of the atmosphere during a time period from the electron beam irradiation to the subsequent heating treatment was 10 ppm.

Next, in the air, the coat was naturally cooled until its temperature became 25° C., and then heating treatment was performed for 30 minutes under such a condition that the temperature of the coat became 120° C., to thereby form a surface layer having a thickness of 2.0 μm.

The ratio S1 [%] of the area of the insulating particles 106 to the total area of the surface layer and the ratio S2 [%] of the area of the electroconductive particles 107 to the total area, the insulating particles and the electroconductive particles being exposed as illustrated in FIG. 3, and the average exposed height L1 [nm] of the insulating particles and the average exposed height L2 [nm] of the electroconductive particles, the insulating particles and the electroconductive particles being exposed to the surface as illustrated in FIG. 4, were measured for the resultant electrophotographic photosensitive member 1, and the ratio “S1/S2”, the sum “S1+S2”, the L1, the L2, the ratio “L1/L2”, the volume [%] of the particles, the niobium localization ratio of the electroconductive particles, and the average circularity of the insulating particles were calculated. The results are shown in Table 5.

<Electrophotographic Photosensitive Members 2 to 42>

Electrophotographic photosensitive members 2 to 42 were each produced in the same manner as in the production of the electrophotographic photosensitive member 1 except that in the production of the electrophotographic photosensitive member 1, the coating liquid 1 for a surface layer was changed as represented by a condition shown in Table 5. The volume resistivity R1 of the insulating particles, the volume resistivity R2 of the electroconductive particles, the S1, the S2, the ratio “S1/S2”, the sum “S1+S2”, the L1, the L2, the ratio “L1/L2”, the volume [%] of the particles, the niobium localization ratio of the electroconductive particles, and the average circularity of the insulating particles in each of the resultant electrophotographic photosensitive members are shown in Table 5.

TABLE 5

| Number of | Number | | | | | | | | | | | | | |
|---|---|---|---|---|---|---|---|---|---|---|---|---|---|---|
| electro- | of coating | Surface | | | | | | | | | | | Niobium | |
| photographic | liquid for | layer | | | | | | | | | | Particle | localization | Average |
| photosensitive | surface | thickness | R1 | R2 | S1 | S2 | S1/S2 | S1+S2 | L1 | L2 | L1/L2 | volume | ratio | circularity |
| member | layer | [μm] | [Ω · cm] | [Ω · cm] | [%] | [%] | [—] | [%] | [nm] | [nm] | [—] | [%] | [—] | [—] |
| 1 | 1 | 2.0 | 1.0 × 10¹⁵ | 1.4 × 10⁵ | 14 | 36 | 0.39 | 50 | 85 | 33 | 2.6 | 60 | 7.7 | 0.99 |
| 2 | 2 | 2.0 | 1.0 × 10¹⁵ | 1.4 × 10⁵ | 59 | 31 | 1.9 | 90 | 136 | 52 | 2.6 | 71 | 7.7 | 0.99 |
| 3 | 3 | 2.0 | 1.0 × 10¹⁵ | 1.4 × 10⁵ | 33 | 17 | 1.9 | 50 | 85 | 33 | 2.6 | 60 | 7.7 | 0.99 |
| 4 | 4 | 2.0 | 1.0 × 10¹⁵ | 1.4 × 10⁵ | 27 | 23 | 1.2 | 50 | 85 | 33 | 2.6 | 60 | 7.7 | 0.99 |
| 5 | 5 | 2.0 | 1.0 × 10¹⁵ | 1.4 × 10⁵ | 16 | 14 | 1.1 | 30 | 60 | 23 | 2.6 | 50 | 7.7 | 0.99 |
| 6 | 6 | 2.0 | 1.0 × 10¹⁵ | 1.4 × 10⁵ | 14 | 36 | 0.39 | 50 | 85 | 33 | 2.6 | 60 | 7.7 | 0.99 |
| 7 | 7 | 2.0 | 1.0 × 10¹⁵ | 1.4 × 10⁵ | 6 | 44 | 0.14 | 50 | 85 | 33 | 2.6 | 60 | 7.7 | 0.99 |
| 8 | 8 | 2.0 | 1.0 × 10¹⁵ | 1.4 × 10⁵ | 38 | 12 | 3.2 | 50 | 50 | 33 | 1.5 | 60 | 7.7 | 0.99 |
| 9 | 9 | 2.0 | 1.0 × 10¹⁵ | 1.4 × 10⁵ | 20 | 30 | 0.67 | 50 | 50 | 33 | 1.5 | 60 | 7.7 | 0.99 |
| 10 | 10 | 2.0 | 1.0 × 10¹⁵ | 2.5 × 10⁶ | 17 | 33 | 0.52 | 50 | 50 | 25 | 2.0 | 60 | 7.0 | 0.99 |
| 11 | 11 | 2.0 | 1.0 × 10¹⁵ | 2.2 × 10⁷ | 14 | 36 | 0.39 | 50 | 50 | 20 | 2.5 | 60 | 5.5 | 0.99 |
| 12 | 12 | 2.0 | 1.0 × 10¹⁵ | 1.4 × 10⁵ | 22 | 28 | 0.79 | 50 | 40 | 33 | 1.2 | 60 | 7.7 | 0.99 |
| 13 | 13 | 2.0 | 1.0 × 10¹⁵ | 7.2 × 10⁶ | 14 | 36 | 0.39 | 50 | 40 | 15 | 2.7 | 60 | 6.1 | 0.99 |
| 14 | 14 | 2.0 | 1.0 × 10¹⁵ | 2.6 × 10⁷ | 18 | 32 | 0.56 | 50 | 150 | 85 | 1.8 | 60 | 5.6 | 0.99 |
| 15 | 15 | 2.0 | 1.0 × 10¹⁵ | 2.6 × 10⁷ | 47 | 13 | 3.6 | 60 | 173 | 98 | 1.8 | 64 | 5.6 | 0.99 |
| 16 | 16 | 2.0 | 1.0 × 10¹⁵ | 1.0 × 10⁷ | 70 | 20 | 3.5 | 90 | 80 | 52 | 1.5 | 71 | 7.7 | 0.99 |
| 18 | 18 | 0.4 | 1.0 × 10¹⁵ | 1.4 × 10⁵ | 9 | 59 | 0.15 | 68 | 164 | 59 | 2.8 | 60 | 7.7 | 0.99 |
| 19 | 19 | 0.4 | 1.0 × 10¹⁵ | 1.4 × 10⁵ | 6 | 39 | 0.15 | 45 | 162 | 57 | 2.8 | 50 | 7.7 | 0.99 |
| 20 | 20 | 0.4 | 1.0 × 10¹⁵ | 1.4 × 10⁵ | 12 | 78 | 0.15 | 90 | 98 | 63 | 1.6 | 71 | 7.7 | 0.99 |
| 21 | 21 | 0.4 | 1.0 × 10¹⁵ | 1.4 × 10⁵ | 9 | 59 | 0.15 | 68 | 94 | 59 | 1.6 | 60 | 7.7 | 0.99 |
| 22 | 22 | 0.4 | 1.0 × 10¹⁵ | 1.4 × 10⁵ | 6 | 39 | 0.15 | 45 | 74 | 59 | 1.3 | 60 | 7.7 | 0.99 |
| 23 | 23 | 2.0 | 1.2 × 10¹³ | 1.4 × 10⁵ | 14 | 36 | 0.39 | 50 | 85 | 33 | 2.6 | 60 | 7.7 | 0.90 |
| 24 | 24 | 2.0 | 2.0 × 10¹² | 1.4 × 10⁵ | 13 | 36 | 0.36 | 50 | 88 | 33 | 2.7 | 60 | 7.7 | 0.86 |
| 25 | 25 | 2.0 | 1.0 × 10¹⁵ | 1.9 × 10³ | 14 | 36 | 0.39 | 50 | 85 | 33 | 2.6 | 60 | — | 0.99 |
| 26 | 26 | 2.0 | 1.0 × 10¹⁵ | 1.4 × 10⁵ | 14 | 36 | 0.39 | 50 | 85 | 33 | 2.6 | 60 | 7.7 | 0.99 |
| 27 | 27 | 2.0 | 1.0 × 10¹⁰ | 1.4 × 10⁵ | 14 | 36 | 0.39 | 50 | 85 | 33 | 2.6 | 60 | 7.7 | 0.83 |
| 28 | 28 | 2.0 | 1.0 × 10¹⁵ | 1.0 × 10⁸ | 14 | 36 | 0.39 | 50 | 85 | 33 | 2.6 | 60 | 4.2 | 0.99 |
| 29 | 29 | 1.5 | 1.0 × 10¹⁵ | 1.0 × 10⁷ | 15 | 18 | 0.83 | 33 | 145 | 120 | 1.2 | 50 | 5.8 | 0.99 |
| 30 | 30 | 1.5 | 1.0 × 10¹⁵ | 2.6 × 10⁷ | 12 | 16 | 0.75 | 28 | 65 | 45 | 1.4 | 41 | 5.6 | 0.99 |
| 31 | 31 | 0.4 | 1.0 × 10¹⁵ | 1.9 × 10⁷ | 12 | 78 | 0.16 | 90 | 44 | 24 | 1.8 | 60 | 5.4 | 0.99 |
| 32 | 32 | 2.0 | 1.0 × 10¹⁵ | 2.4 × 10⁷ | 16 | 34 | 0.47 | 50 | 85 | 40 | 2.1 | 60 | 5.7 | 0.99 |
| 33 | 33 | 0.4 | 3.5 × 10¹³ | 1.9 × 10⁷ | 11 | 70 | 0.16 | 81 | 54 | 30 | 1.8 | 41 | 5.4 | 0.89 |
| 34 | 34 | 0.4 | 2.0 × 10¹² | 2.4 × 10⁷ | 11 | 71 | 0.15 | 82 | 177 | 72 | 2.5 | 50 | 5.7 | 0.86 |
| 35 | 35 | 2.0 | 3.5 × 10¹³ | 1.9 × 10⁷ | 17 | 33 | 0.52 | 50 | 30 | 15 | 2.0 | 60 | 5.4 | 0.89 |
| 36 | 36 | 1.5 | 1.0 × 10¹⁵ | 2.6 × 10⁷ | 11 | 14 | 0.79 | 25 | 60 | 40 | 1.5 | 38 | 5.6 | 0.99 |
| 37 | 37 | 0.4 | 3.5 × 10¹³ | 1.9 × 10⁷ | 11 | 70 | 0.16 | 81 | 51 | 30 | 1.7 | 38 | 5.4 | 0.89 |
| 38 | 38 | 0.4 | 4.0 × 10¹³ | 1.9 × 10⁷ | 11 | 70 | 0.16 | 81 | 50 | 30 | 1.7 | 41 | 5.4 | 0.89 |
| 39 | 39 | 2.0 | 2.0 × 10¹² | 1.4 × 10⁵ | 5 | 35 | 0.14 | 40 | 65 | 35 | 1.9 | 50 | 7.7 | 0.86 |
| 40 | 40 | 2.0 | 1.8 × 10¹² | 1.4 × 10⁵ | 5 | 35 | 0.14 | 40 | 70 | 35 | 2.0 | 50 | 7.7 | 0.86 |
| 41 | 41 | 2.0 | 1.0 × 10¹⁵ | 2.4 × 10⁷ | 75 | 20 | 3.8 | 95 | 92 | 74 | 1.3 | 75 | 5.7 | 0.99 |
| 42 | 42 | 2.0 | 1.0 × 10¹⁵ | 2.1 × 10⁵ | 14 | 36 | 0.39 | 50 | 85 | 33 | 2.6 | 60 | 7.7 | 0.99 |

### COMPARATIVE EXAMPLES

<Production of Electrophotographic Photosensitive Member 43>

A support, an undercoat layer, a charge-generating layer, a charge-transporting layer, and a surface layer were produced by the following methods.

[Electrophotographic Photosensitive Member 43]

<Support>

An aluminum cylinder having a diameter of 24 mm and a length of 257 mm was used as a support (cylindrical support).

<Undercoat Layer>

A dispersion liquid having the following composition was diluted two-fold with the same mixed solvent, and the diluted liquid was left at rest overnight. After that, the liquid was filtered (filter; RIGIMESH 5 μm filter manufactured by Nihon Pall Ltd. was used) to produce a coating liquid for an undercoat layer.
Polyamide resin CM8000 (manufactured by Toray Industries, Inc.) 1 part
Titanium oxide SMT-500SAS (manufactured by Tayca Corporation) 3 parts
Methanol 10 parts

The resin and titanium oxide were dispersed in methanol by using a sand mill as a disperser in a batch manner for 10 hours.

The above-mentioned coating liquid was applied onto the support by a dip coating method so that its dry thickness became 2 μm. Thus, an undercoat layer was formed.

<Formation of Charge-generating Layer>
Charge-generating material: A titanyl phthalocyanine pigment (titanyl phthalocyanine pigment having the maximum diffraction peak at at least a position of 27.3° in Cu-Kα characteristic X-ray diffraction spectrum measurement) 20 parts
Polyvinyl butyral resin (#6000-C: manufactured by Denki Kagaku Kogyo K.K.) 10 parts
t-Butyl acetate 700 parts
4-Methoxy-4-methyl-2-pentanone 300 parts
   Those materials were mixed, and the mixture was subjected to dispersion treatment with a sand mill for 10 hours to produce a coating liquid for a charge-generating layer. The above-mentioned coating liquid was applied onto the undercoat layer by a dip coating method to form a charge-generating layer having a dry thickness of 0.3 μm.

<Formation of Charge-Transporting Layer>
Charge-transporting material: (4,4′-dimethyl-4″-(β-phenylstyryl)triphenylamine) 225 parts
Binder: Polycarbonate (Z300: manufactured by Mitsubishi Gas Chemical Company, Inc.) 300 parts
Antioxidant (Irganox 1010: manufactured by Nihon Ciba-Geigy K.K.) 6 parts
Tetrahydrofuran (THF) 1,600 parts
Toluene 400 parts
Silicone oil (KF-54: manufactured by Shin-Etsu Chemical Co., Ltd.) 1 part
   Those materials were mixed and dissolved to produce a coating liquid for a charge-transporting layer. The above-mentioned coating liquid was applied onto the charge-generating layer with a circular slide hopper coater to form a charge-transporting layer having a dry thickness of 20 μm.

<Surface Layer>
Titanium oxide particles (niobium element: 0.030 mass %, average primary particle diameter: 110 nm) 10 parts
Curable compound represented by the following formula (0-3) 10 parts
Polymerization initiator (1-hydroxycyclohexyl(phenyl)methanone) 1 part
n-Propyl alcohol 40 parts

The above-mentioned components were dispersed with a sand mill for 2 hours to produce a coating liquid for a surface layer. The coating liquid for a surface layer was applied onto the charge-transporting layer by dip coating. After the application, the liquid was irradiated with UV light through use of a metal halide lamp for 1 minute to form a surface layer having a dry thickness of 2.0 μm. Thus, an electrophotographic photosensitive member 43 was produced.

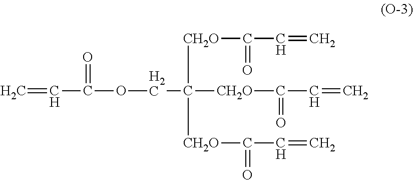

<Production of Electrophotographic Photosensitive Member 44>

5 Grams of tin oxide (number-average primary particle diameter: 100 nm) serving as untreated metal oxide particles (untreated parent particles) was added to 10 mL of methanol, and was dispersed therein with a US homogenizer at room temperature for 30 minutes. Next, 0.25 g of 3-methacryloxypropyltrimethoxysilane (“KBM-503”, manufactured by Shin-Etsu Chemical Co., Ltd.) serving as a reactive surface treatment agent and 10 mL of toluene were added to the dispersed product, and the mixture was stirred at room temperature for 60 minutes. The solvent was removed with an evaporator, and then the residue was heated at 120° C. for 60 minutes to provide metal oxide particles having surfaces treated with the reactive surface treatment agent.

Subsequently, 5 g of the metal oxide particles having surfaces treated with the reactive surface treatment agent, which had been obtained in the foregoing, were added to 40 g of 2-butanol, and were dispersed therein with a US homogenizer at room temperature for 60 minutes. Next, 0.15 g of a linear silicone surface treatment agent (“KF-9908”, manufactured by Shin-Etsu Chemical Co., Ltd.) was added to the dispersed product, and was further dispersed therein at room temperature for 60 minutes with the US homogenizer. After the dispersion, the solvent was volatilized under room temperature, and the residue was dried at 120° C. for 60 minutes to produce surface-treated particles.

The following components were mixed in the following amounts to prepare a coating liquid for forming a surface layer (coating liquid for forming the outermost layer). Subsequently, the resultant coating liquid for forming a surface layer was applied onto the charge-transporting layer described in the electrophotographic photosensitive member 1 by dip coating, and was then irradiated with UV light through use of a metal halide lamp at 16 mW/cm² for 1 minute (integrated light quantity: 960 mJ/cm²) to form a surface layer having a dry thickness of 3.0 μm. Thus, an electrophotographic photosensitive member 44 was produced.
Radically polymerizable monomer (trimethylolpropane trimethacrylate) 120 parts by mass
Surface-treated particles 100 parts by mass
Polymerization initiator (manufactured by BASF Japan Ltd., IRGACURE (trademark) 819) 10 parts by mass
2-Butanol 400 parts by mass

<Production of Electrophotographic Photosensitive Member 45>

Al₂O₃ (purity: 99.9%) and Cu₂O (99.9%) were mixed at a molar ratio of 1:1, and the mixture was calcined in an Ar atmosphere at 1,100° C. for 4 days. After that, the calcined product was molded into a pellet shape, and was sintered at 1,100° C. for 2 days to provide a sintered body. After that, the sintered body was coarsely pulverized to several hundreds of micrometers, and then the resultant coarse particles were dispersed in a solvent with a wet medium dispersion-type device to provide untreated CuAlO₂ having a number-average primary particle diameter of 0.10 μm.

100 Parts by mass of the untreated CuAlO₂, 30 parts by mass of a surface treatment agent “KBM-503”, and 1,000 parts by mass of methyl ethyl ketone were loaded into a wet sand mill (alumina beads each having a diameter of 0.5 mm), and were mixed at 30° C. for 6 hours. After that, methyl ethyl ketone and the alumina beads were separated by filtration, and the residue was dried at 60° C. to provide surface-treated CuAlO₂.

Next, the following coating liquid compositions were mixed and stirred to be sufficiently dissolved and dispersed. Thus, a coating liquid for forming a surface layer was prepared.
P-type semiconductor particles 100 parts by mass
Crosslinked resin particles (melamine-formamide resin particles “EPOSTAR S6 (number-average primary particle diameter: 0.5 μm)” (manufactured by Nippon Shokubai Co., Ltd.)) 30 parts by mass
Polymerizable compound (exemplified compound (M1)) 100 parts by mass
Polymerization initiator (“IRGACURE 819”: manufactured by BASF Japan Ltd.) 15 parts by mass
Solvent: sec-butanol 400 parts by mass
Solvent: methyl isopropyl ketone 100 parts by mass

The coating liquid for forming a surface layer was applied onto the charge-transporting layer described in the electrophotographic photosensitive member 1 with a circular slide hopper coater, and was irradiated with UV light through use of a metal halide lamp for 1 minute to form a surface layer having a dry thickness of 3.0 Thus, an electrophotographic photosensitive member 45 was produced.

<Production of Electrophotographic Photosensitive Member 46>

Parts of trimethylolpropane triacrylate (manufactured by Tokyo Chemical Industry Co., Ltd.), 20 parts of alumina particles AA-05 (manufactured by Sumitomo Chemical Company, Limited) having an average primary particle diameter of 500 nm, 10 parts of aluminum-doped zinc oxide particles having an average primary particle diameter of 165 nm, the particles serving as electroconductive particles, 3.5 parts of a photopolymerization initiator IRGACURE 184 (1-hydroxycyclohexyl phenyl ketone) (manufactured by Ciba Specialty Chemicals), and 860 parts of isopropyl alcohol were mixed to provide a coating liquid for a surface layer.

An electrophotographic photosensitive member 46 was produced in the same manner as in the production of the electrophotographic photosensitive member 1 except that the resultant coating liquid for a surface layer was used.

<Production of Electrophotographic Photosensitive Member 47>

First, a mixed liquid of 100 parts of tin oxide, 30 parts of a compound represented by the chemical formula S-15 (CH₂═C(CH₃)COO(CH₂)₃Si(OCH₃)₃), and 300 parts of a mixed solvent containing toluene and isopropyl alcohol at a mass ratio of 1/1 was loaded into a sand mill together with zirconia beads, and the mixture was stirred at about 40° C. and a rotation speed of 1,500 rpm so that the surfaces of the particles of the tin oxide were treated with the surface treatment agent having a reactive organic group. Further, the above-mentioned treated mixture was removed, and was loaded into a Henschel mixer, followed by stirring at a rotation speed of 1,500 rpm for 15 minutes. After that, the mixture was dried at 120° C. for 3 hours so that the surface treatment of the tin oxide was completed. Thus, surface-treated tin oxide was obtained. The fact that the surfaces of the tin oxide particles were covered with the surface treatment agent represented by the chemical formula S-15 by the above-mentioned surface treatment was recognized by detecting the peak of Si with a fluorescent X-ray analyzer “XRF-1700 (manufactured by Shimadzu Corporation).”

Tin oxide manufactured by CIK NanoTek Corporation (number-average primary particle diameter: 20 nm, volume resistivity: 1.05×10⁵ (Ω·cm)) was used as the tin oxide.

An electrophotographic photosensitive member 47 was produced in the same manner as in the production of the electrophotographic photosensitive member 1 except that 10.0 parts of the above-mentioned surface-treated tin oxide was used as electroconductive particles, and 2.0 parts of silica particles (“AEROSIL RX-50”, manufactured by Nippon Aerosil Co., Ltd.) were used as insulating particles.

<Electrophotographic Photosensitive Members 48 to 54>

Electrophotographic photosensitive members 48 to 54 were each produced in the same manner as in the production of the electrophotographic photosensitive member 1 except that in the production of the electrophotographic photosensitive member 1, the coating liquid 1 for a surface layer was changed as represented by a condition shown in Table 5. The R1, the R2, the S1, the S2, the ratio “S1/S2”, the sum “S1+S2”, the L1, the L2, the ratio “L1/L2”, the volume [%] of the particles, the niobium localization ratio of the electroconductive particles, and the average circularity of the insulating particles in each of the resultant electrophotographic photosensitive members are shown in Table 6.

TABLE 6

| | Number | | | | | | | | | | | | | |
|---|---|---|---|---|---|---|---|---|---|---|---|---|---|---|
| | of | | | | | | | | | | | | | |
| | coating | | | | | | | | | | | | | |
| Number of | liquid | Surface | | | | | | | | | | | Niobium | |
| electrophotographic | for | layer | | | | | | | | | | Particle | localization | Average |
| photosensitive | surface | thickness | R1 | R2 | S1 | S2 | S1/S2 | S1+S2 | L1 | L2 | L1/L2 | volume | ratio | circularity |
| member | layer | [μm] | [Ω · cm] | [Ω · cm] | [%] | [%] | [—] | [%] | [nm] | [nm] | [—] | [%] | [—] | [—] |
| 43 | — | 2.0 | 4.1 × 10¹¹ | — | 10 | — | — | 10 | 11 | — | — | 17 | 1.0 | 0.85 |
| 44 | — | 3.0 | — | 1.1 × 10² | — | 8 | — | 8 | — | 9 | — | 15 | — | — |
| 45 | — | 3.0 | 6.0 × 10¹⁴ | 6.0 × 10⁷ | 1 | 9 | 0.11 | 10 | 100 | 20 | 5.0 | 33 | 1.0 | 0.99 |
| 46 | — | 2.0 | 2.0 × 10¹⁴ | 4.0 × 10⁵ | 2 | 3 | 0.67 | 5 | 50 | 17 | 3.0 | 9 | 1.0 | 0.99 |
| 47 | — | 2.0 | 8.0 × 10¹⁴ | 1.1 × 10⁵ | 1 | 6 | 0.17 | 7 | 7 | 3 | 2.5 | 15 | 1.0 | 0.99 |
| 48 | 43 | 2.0 | 1.0 × 10¹⁵ | 1.0 × 10⁷ | 7 | 23 | 0.30 | 30 | 60 | 60 | 1.0 | 50 | 5.6 | 0.99 |
| 49 | 44 | 2.0 | 1.0 × 10¹⁵ | 1.0 × 10⁷ | 6 | 64 | 0.09 | 70 | 195 | 52 | 3.8 | 67 | 5.7 | 0.99 |
| 50 | 45 | 2.0 | 1.0 × 10¹⁵ | 1.0 × 10⁷ | 76 | 14 | 5.4 | 90 | 64 | 64 | 1.0 | 71 | 5.7 | 0.99 |
| 51 | 46 | 2.0 | 1.0 × 10¹⁵ | 1.0 × 10⁷ | 83 | 15 | 5.7 | 98 | 145 | 55 | 2.6 | 80 | 7.7 | 0.99 |
| 52 | 47 | 2.0 | 1.0 × 10¹⁵ | 2.6 × 10⁷ | 11 | 19 | 0.58 | 30 | 35 | 60 | 0.6 | 50 | 5.6 | 0.99 |
| 53 | 48 | 2.0 | 1.0 × 10¹⁵ | 5.5 × 10⁹ | 8 | 22 | 0.36 | 30 | 60 | 23 | 2.6 | 50 | 2.0 | 0.99 |
| 54 | 49 | 2.0 | 5.5 × 10⁹ | 7.2 × 10⁶ | 9 | 21 | 0.43 | 30 | 23 | 11 | 2.2 | 50 | 6.1 | 0.82 |

### Production Example of Toner Particles 1

(Preparation of Aqueous Medium 1)

650.0 Parts of ion-exchanged water and 14.0 parts of sodium phosphate (manufactured by RASA Industries, Ltd., dodecahydrate) were loaded into a reaction vessel including a stirring machine, a temperature gauge, and a reflux tube, and the temperature of the mixture was held at 65° C. for 1.0 hour while the vessel was purged with nitrogen.

While the mixture was stirred with T.K. HOMOMIXER (manufactured by Tokushu Kika Kogyo Co., Ltd.) at 15,000 rpm, an aqueous solution of calcium chloride obtained by dissolving 9.2 parts of calcium chloride (dihydrate) in 10.0 parts of ion-exchanged water was collectively loaded into the mixture to prepare an aqueous medium containing a dispersion stabilizer. Further, 10 mass % hydrochloric acid was loaded into the aqueous medium to adjust its pH to 5.0. Thus, an aqueous medium 1 was obtained.

(Preparation of Polymerizable Monomer Composition)
Styrene 60.0 parts by mass
C.I. Pigment Blue 15:3 6.5 parts by mass

The materials were loaded into an attritor (manufactured by Mitsui Miike Kakoki K.K.), and were dispersed with zirconia particles each having a diameter of 1.7 mm at 220 rpm for 5.0 hours, followed by the removal of the zirconia particles. Thus, a colorant dispersion liquid was prepared.
Styrene 20.0 parts by mass
n-Butyl acrylate 20.0 parts by mass
Crosslinking agent (divinylbenzene) 0.3 part by mass
Saturated polyester resin 5.0 parts by mass (polycondensate of propylene oxide-modified bisphenol A (2-mol adduct) and terephthalic acid (at a molar ratio of 10:12), glass transition temperature (Tg): 68° C., weight-average molecular weight (Mw): 10,000, molecular weight distribution (Mw/Mn): 5.12)
Fischer-Tropsch wax (melting point: 78° C.) 7.0 parts by mass

Meanwhile, the materials were added to the above-mentioned colorant dispersion liquid, and the mixture was heated to 65° C. After that, the materials were uniformly dissolved and dispersed in the dispersion liquid with T.K. HOMOMIXER (manufactured by Tokushu Kika Kogyo Co., Ltd.) at 500 rpm to prepare a polymerizable monomer composition.

(Granulating Step)

While the temperature of the aqueous medium 1 was adjusted to 70° C., and the number of revolutions of the T.K. HOMOMIXER was kept at 15,000 rpm, the polymerizable monomer composition was loaded into the aqueous medium 1, and 10.0 parts by mass of t-butyl peroxypivalate serving as a polymerization initiator was added thereto. The mixture was granulated as it was with the stirring device for 10 minutes while the number of revolutions was maintained at 15,000 rpm.

(Polymerizing Step and Distilling Step)

After the granulating step, the stirring machine was changed to a propeller stirring blade, and polymerization was performed for 5.0 hours by holding the temperature of the granulated product at 70° C. while stirring the granulated product at 150 rpm. Further, polymerization was performed by increasing the temperature to 85° C. and holding the temperature at the value for 2.0 hours. After that, the reflux tube of the reaction vessel was replaced with a cooling tube, and an unreacted polymerizable monomer was evaporated by performing distillation for 6 hours through the heating of the resultant slurry to 100° C. Thus, a resin particle dispersion liquid containing toner particles 1 was obtained.

### Production Example of External Additive 1

An external additive 1 was produced as described below.

150 Parts by mass of 5% ammonia water was loaded into a 1.5-liter glass-made reaction vessel including a stirring machine, a dropping nozzle, and a temperature gauge to provide an alkali catalyst solution. After the temperature of the alkali catalyst solution had been adjusted to 50° C., 100 parts by mass of tetraethoxysilane and 50 parts by mass of 5% ammonia water were simultaneously dropped into the solution while the solution was stirred. The mixture was subjected to a reaction for 8 hours to provide a silica fine particle dispersion liquid. After that, the resultant silica fine particle dispersion liquid was dried by spray drying, and was shredded with a pin mill to provide silica fine particles. Herein, the external additives 1 having different number-average particle diameters R of their primary particles were obtained by appropriately changing the above-mentioned production conditions.

### Production Example of Toner 1

100.00 Parts by mass of the toner particles 1 and 1.00 part by mass of the external additive 1 were loaded into a Henschel mixer (Model FM10C manufactured by Nippon Coke & Engineering Co., Ltd.) having a jacket through which water at 7° C. had been passed. Next, after the water temperature in the jacket had been stabilized at 7° C.±1° C., the materials were mixed for 10 minutes while the peripheral speed of the rotating blade of the mixer was set to 38 m/sec. In the mixing, the amount of the water to be passed through the jacket was appropriately adjusted so that a temperature in the tank of the Henschel mixer did not exceed 25° C. The resultant mixture was sieved with a mesh having an aperture of 75 μm to provide a toner 1.

[Evaluation]

<Calculation of Primary Particle Diameter of Electroconductive Particles>

First, the electrophotographic photosensitive member was entirely immersed in methyl ethyl ketone (MEK) in a graduated cylinder and irradiated with an ultrasonic wave to peel off resin layers, and then the support of the electrophotographic photosensitive member was taken out. Next, insoluble matter that did not dissolve in MEK (the photosensitive layer and the surface layer containing the electroconductive particles) was filtered, and was brought to dryness with a vacuum dryer. Further, the resultant solid was suspended in a mixed solvent of tetrahydrofuran (THF) and methylal at a volume ratio of 1:1, insoluble matter was filtered, and then the filtration residue was recovered and brought to dryness with a vacuum dryer. Through this operation, the electroconductive particles and the resin of the surface layer were obtained. Further, the filtration residue was heated in an electric furnace to 500° C. so as to leave only the electroconductive particles as solids, and the electroconductive particles were collected. To secure an amount of the electroconductive particles required for measurement, a plurality of electrophotographic photosensitive members were similarly treated.

Part of the collected electroconductive particles were dispersed in isopropanol (IPA), and the dispersion liquid was dropped onto a grid mesh with a support membrane (Cu150J, manufactured by JEOL Ltd.), followed by the observation of the electroconductive particles in the STEM mode of a scanning transmission electron microscope (JEM2800, manufactured by JEOL Ltd.). The observation was performed at a magnification of from 500,000 to 1,200,000 so as to facilitate the calculation of the particle diameter of each of the electroconductive particles, and STEM images of 100 electroconductive particles were taken. At this time, the following settings were adopted: an acceleration voltage of 200 kV, a probe size of 1 nm, and an image size of 1,024×1,024 pixels. Through use of the resultant STEM images, a primary particle diameter was measured with image processing software “Image-Pro Plus (manufactured by Media Cybernetics, Inc.)”. First, a scale bar displayed in the lower portion of the STEM image is selected through use of the straight line tool (Straight Line) of the tool bar. When the “Set Scale” of the “Analyze” menu is selected under the state, a new window is opened, and the pixel distance of a selected straight line is input in the “Distance in Pixels” column. The value (e.g., 100) of the scale bar is input in the “Known Distance” column of the window, and the unit (e.g., nm) of the scale bar is input in the “Unit of Measurement” column, followed by the clicking of OK. Thus, scale setting is completed. Next, a straight line was drawn so as to coincide with the maximum diameter of an electroconductive particle through use of the straight line tool, and the particle diameter was calculated. The same operation was performed for 100 electroconductive particles, and the number average of the resultant values (maximum diameters) was adopted as the primary particle diameter of the electroconductive particles.

<Calculation of Niobium Atom/Titanium Atom Concentration Ratio in Electroconductive Particles to be Incorporated into Electrophotographic Photosensitive Member>

One 5-millimeter square sample piece was cut out of the photosensitive member, and was cut to a thickness of 200 nm with an ultrasonic ultramicrotome (Leica, UC7) at a cutting speed of 0.6 mm/s to produce a sliced sample. The sliced sample was observed at a magnification of from 500,000 to 1,200,000 in the STEM mode of a scanning transmission electron microscope (JEOL Ltd., JEM2800) having connected thereto an energy-dispersive X-ray spectroscopy (EDS) analyzer.

Of the sections of the electroconductive particles observed, the sections of the electroconductive particles each having a maximum diameter that was about 0.9 or more times and about 1.1 or less times as large as the primary particle diameter calculated in the foregoing were selected through visual observation. Subsequently, spectra of the constituent elements of the sections of the selected electroconductive particles were collected through use of the EDS analyzer to produce EDS mapping images. The collection and analysis of the spectra were performed through use of NSS (Thermo Fisher Scientific). Collection conditions were set to an acceleration voltage of 200 kV, a probe size of 1.0 nm or 1.5 nm appropriately selected so as to achieve a dead time of 15 or more and 30 or less, a mapping resolution of 256×256, and a Frame number of 300. The EDS mapping images were obtained for 100 sections of the electroconductive particles.

The thus obtained EDS mapping images are each analyzed to calculate a ratio between a niobium atom concentration (atomic %) and a titanium atom concentration (atomic %) at each of the central portion of a particle and an inside portion at 5% of the maximum diameter of a measurement particle from the surface of the particle. Specifically, first, the “Line Extraction” button of NSS is pressed to draw a straight line so as to coincide with the maximum diameter of the particle, and information is obtained on an atom concentration (atomic %) on the straight line extending from one surface, passing through the inside of the particle, and reaching the other surface. When the maximum diameter of the particle obtained at this time falls within the range of less than 0.9 times or more than 1.1 times as large as the primary particle diameter calculated in the foregoing, the particle was excluded from the subsequent analysis. (Only particles each having a maximum diameter that falls within the range of 0.9 or more times and 1.1 or less times as large as the primary particle diameter were subjected to the analysis described below.) Next, on the surfaces on both sides of the particle, the niobium atom concentration (atomic %) at the inside portion at 5% of the maximum diameter of the measurement particle from the surface of the particle is read. Similarly, the “titanium atom concentration (atomic %) at the inside portion at 5% of the maximum diameter of the measurement particle from the surface of the particle” is obtained. Then, through use of those values, the “concentration ratio between the niobium atom and the titanium atom at the inside portion at 5% of the maximum diameter of the measurement particle from the surface of the particle” on each of the surfaces on both sides of the particle is obtained from the following equation.

Concentration ratio between niobium atom and titanium atom at inside portion at 5% of maximum diameter of measurement particle from surface of particle=(niobium atom concentration (atomic %) at inside portion at 5% of maximum diameter of measurement particle from surface of particle)/(titanium atom concentration (atomic %) at inside portion at 5% of maximum diameter of measurement particle from surface of particle)

The smaller value out of the resultant two concentration ratios is adopted as the “concentration ratio between the niobium atom and the titanium atom at the inside portion at 5% of the maximum diameter of the measurement particle from the surface of the particle” in the present invention.

In addition, a niobium atom concentration (atomic %) and a titanium atom concentration (atomic %) at a position located on the above-mentioned straight line and coinciding with the middle point of the maximum diameter are read. Through use of those values, the “concentration ratio between the niobium atom and the titanium atom at the central portion of the particle” is obtained from the following equation.

Concentration ratio between niobium atom and titanium atom at central portion of particle=(niobium atom concentration (atomic %) at central portion of particle)/(titanium atom concentration (atomic %) at central portion of particle)

The “concentration ratio calculated as niobium atom concentration/titanium atom concentration at the inside portion at 5% of the maximum diameter of the measurement particle from the surface of the particle relative to the concentration ratio calculated as niobium atom concentration/titanium atom concentration at the central portion of the particle” is calculated by the following equation.

(Concentration ratio between niobium atom and titanium atom at inside portion at 5% of maximum diameter of measurement particle from surface of particle)/(concentration ratio between niobium atom and titanium atom at central portion of particle)

<Calculation of Exposed Heights of Particles in Surface Layer of Electrophotographic Photosensitive Member and Area Ratios of Exposed Portions Thereof>

Herein, in the present invention, the exposed height L1 [nm] of the insulating particles and the exposed height L2 [nm] of the electroconductive particles were measured through sectional observation with a FIB-SEM ([NVision], manufactured by Carl Zeiss AG). Sections of the electrophotographic photosensitive members produced in Examples were observed. The observation was performed at 3 sites for each of the samples, and the maximum of the heights of the insulating particles or the electroconductive particles exposed to a portion above the surface of the binder resin of the surface layer of each sample with respect to the average height of the surface of the binder resin was measured for each image. The resultant 3 values were averaged, and the average exposed height of the insulating particles and that of the electroconductive particles were represented by L1 [nm] and L2 [nm], respectively (see FIG. 4). The electroconductive particles and the insulating particles were distinguished from each other by using the SEM-EDX function of the FIB-SEM. Positions corresponding to ¼, ½, and ¾ of the length of the photosensitive member from above when the photosensitive member was divided into 4 equal sections in its longitudinal direction were used as the 3 sites at which the sectional observation was performed, and the observation was performed while the positions were shifted from each other by 120° in the peripheral direction thereof. In addition, the surface shape of the photosensitive member was measured with a scanning probe microscope (“JSPM-5200”, manufactured by JEOL Ltd.), and it was recognized that the surface shape coincided with the results of the measurement with the FIB-SEM. A distinction between the particles in the measurement with the scanning probe microscope was performed as follows: measured positions were marked after the measurement, and the particles were distinguished from each other by using the EDX function of a scanning electron microscope (hereinafter also referred to as “SEM”, “JSM-7800F”, manufactured by JEOL Ltd.).

In addition, the exposed area S1 [%] of the insulating particles and the exposed area S2 [%] of the electroconductive particles were measured through surface observation with a FIB-SEM. The electrophotographic photosensitive members produced in Examples were each cut into a size measuring about 5 mm square. The surface layer of the photosensitive member was observed from above with the SEM, and the images of 3 sites were taken for each photosensitive member. The resultant images were subjected to image processing, and the ratio of the gross area of insulating particle portions to the total observed area and the ratio of the gross area of electroconductive particle portions to the total observed area were represented by S1 [%] and S2 [%], respectively (see FIG. 3). The electroconductive particles and the insulating particles were distinguished from each other by using the SEM-EDX function of the SEM. Positions corresponding to ¼, ½, and ¾ of the length of the photosensitive member from above when the photosensitive member was divided into 4 equal sections in its longitudinal direction were used as the 3 sites at which the surface observation was performed, and the observation was performed while the positions were shifted from each other by 120° in the peripheral direction thereof. In addition, the surface shape of the photosensitive member was measured with a scanning probe microscope (“JSPM-5200”, manufactured by JEOL Ltd.), and it was recognized that the surface shape coincided with the results of the measurement with the FIB-SEM. A distinction between the particles in the measurement with the scanning probe microscope was performed as follows: measured positions were marked after the measurement, and the particles were distinguished from each other by using the EDX function of a scanning electron microscope (hereinafter also referred to as “SEM”, “JSM-7800F”, manufactured by JEOL Ltd.).

<Calculation of Ratio of Total Sum of Volumes of Electroconductive Particles and Insulating Particles to be Incorporated into Surface Layer of Electrophotographic Photosensitive Member to Total Volume of Surface Layer, and Determination of Thickness of Surface Layer>

The ratio of the total sum of the volumes of the electroconductive particles and the insulating particles to be incorporated into the surface layer of each of the electrophotographic photosensitive members to the total volume of the surface layer was calculated from the addition amounts, densities, and true specific gravities of the monomer having a polymerizable functional group and the particles to be used in the coating liquid for a surface layer used in the photosensitive member. For the specific gravities of a polymerization product (the binder resin) obtained after the polymerization of the monomer having a polymerizable functional group, and the electroconductive particles and the insulating particles, reference can be made to values published in the manufacturers of the respective materials and the database “POLYINFO” of National Institute for Materials Science.

In addition, when the ratio is determined from the electrophotographic photosensitive member, for example, the following method is available.

Sections of each of the electrophotographic photosensitive members produced in Examples were observed. The manner in which the particles were laminated in such a surface layer as illustrated in FIG. 1 or FIG. 4 was judged. Samples subjected to the sectional observation were collected from positions determined as follows: positions corresponding to ¼, ½, and ¾ of the length of the electrophotographic photosensitive member from an end portion thereof when the electrophotographic photosensitive member was divided into 4 equal sections in its longitudinal direction were selected, and were shifted from each other by 120° in the peripheral direction thereof 5-Millimeter square sample pieces were cut out of each of the electrophotographic photosensitive members, and their surface layers were each reconstructed into a three-dimensional object measuring 2 μm by 2 μm by 2 μm with the Slice & View function of a FIB-SEM.

Conditions for the Slice & View function were set as described below.

Processing of sample for analysis: FIB method
Processing and observation device: NVision 40 manufactured by SII/Zeiss
Slice interval: 10 nm

(Observation Conditions)

Acceleration voltage: 1.0 kV
Sample tilt: 54°

### WD: 5 mm

Detector: BSE detector
Aperture: 60 μm, high current

### ABC: ON

Image resolution: 1.25 nm/pixel

In addition, a measurement environment has a temperature of 23° C. and a pressure of 1×10⁻⁴ Pa. Strata 400S manufactured by FEI (sample tilt: 52°) may also be used as the processing and observation device.

The analysis is performed in a region measuring 2 μm long by 2 μm wide, and pieces of information on the respective sections are integrated to determine a volume V per unit volume measuring 2 μm long by 2 μm wide by 2 μm thick (8 μm³) in the surface of the surface layer. In addition, the images of the respective sections were analyzed with image processing software “Image-Pro Plus” manufactured by Media Cybernetics, Inc.

The content of the electroconductive particles and the insulating particles in the total volume of the surface layer was calculated from a difference in contrast between the layer and the particles obtained by the Slice & View function of a FIB-SEM. In addition, the volume V of the particles of the present invention in a volume measuring 2 μm by 2 μm by 2 μm (unit volume: 8 μm³) was determined in each of the 3 sample pieces based on the information obtained from the image analysis, and the content [vol %] (=V μm³/8 μm³×100) of the electroconductive particles and the insulating particles was calculated. The average of the values of the contents of the particles in the respective sample pieces was adopted as the content [vol %] of the respective electroconductive particles and insulating particles of the present invention in the surface layer with respect to the total volume of the surface layer. The composition of the particles was determined by using the SEM-EDX function of the SEM. In the cross section of the electrophotographic photosensitive member as shown in FIG. 1, the length from the interface between the charge-transporting layer and the surface layer to the exposed surface of the binder resin in the surface layer was adopted as the thickness of each of the samples of the surface layer, and the average value of the thickness of each of the samples was adopted as the thickness of the surface layer. The results are shown in Tables 5 and 6.

<Evaluation of Injection Chargeability>

A reconstructed machine of a laser beam printer (electrophotographic apparatus) (product name: HP LaserJet Enterprise Color M553dn, manufactured by Hewlett-Packard Company) was used in injection chargeability measurement. The reconstructed machine used in the evaluation was reconstructed so that an image exposure amount, the amount of a current flowing from a charging roller to the support of an electrophotographic photosensitive member (hereinafter also referred to as “total current”), and a voltage to be applied to the charging roller were each able to be regulated and measured.

In addition, the process cartridge for a cyan color of the above-mentioned reconstructed machine was reconstructed, and a potential probe (model 6000B-8: manufactured by Trek Japan) was mounted at its development position. Next, a surface potentiometer (model 344: manufactured by Trek Japan) was used to enable the measurement of a surface potential at the central portion of the electrophotographic photosensitive member.

Under an environment having a temperature of 30° C. and a humidity of 80% RH, the electrophotographic photosensitive member was mounted on the reconstructed machine. A DC voltage of 600 V was applied to the charging roller, and the photosensitive member was charged while being rotated at 60 rpm. The surface potential of the photosensitive member at this time was represented by VC, and the injection charging ratio thereof, which was equal to −VC/600, was calculated. The photosensitive member was ranked on 5 stages of from A to E in accordance with the value of the injection charging ratio, and the ranks A to D were each regarded as the rank at which the effect of the present invention was expressed. The results are shown in Tables 7 and 8.

A: The injection charging ratio is 0.90 or more.
B: The injection charging ratio is 0.80 or more and less than 0.90.
C: The injection charging ratio is 0.70 or more and less than 0.80.
D: The injection charging ratio is 0.50 or more and less than 0.70.
E: The injection charging ratio is less than 0.50.

<Evaluation of Initial Image Smearing>

Subsequently, the reconstructed machine and the electrophotographic photosensitive member described above were left to stand under each of the following environments for 24 hours or more: a normal-humidity environment having a temperature of 23.0° C. and a humidity of 50% RH; and a high-humidity environment having a temperature of 32.5° C. and a humidity of 80% RH. After that, the electrophotographic photosensitive member left to stand under each of the environments was mounted on the cyan color cartridge of the reconstructed machine.

Next, a voltage was applied to the electrophotographic photosensitive member while being increased from −400 V to −2,000 V in increments of 100 V in a stepwise manner, and the total current at each applied voltage was measured. Then, a graph whose axis of abscissa and axis of ordinate indicated the applied voltage and the total current, respectively was prepared, and the applied voltage at which the measured current value deviated from a first approximate curve in the applied voltage range of from −400 V to −800 V by 100 μA was determined, followed by the setting of the applied voltage to the determined value.

Next, A4 size plain paper (product name: CS-680 (68 g/m²), manufactured by Canon Marketing Japan Inc.) was used as paper, and a solid image was output thereon by using a cyan color alone. An image exposure light quantity was set so that the density of the solid image on the paper measured with a spectral densitometer (product name: X-Rite 504, manufactured by X-Rite, Inc.) became 1.45. Next, a square lattice image having a line width of 0.1 mm and a line interval of 10 mm was continuously output on 10 sheets of the A4 size paper by using a cyan color alone. The resultant images were ranked on 5 stages of from A to E based on the following criteria. The ranks A to D out of the ranks were each regarded as the rank at which the effect of the present invention was expressed. The evaluation results are shown in Tables 7 and 8.

A: No abnormalities are found in the lattice images.
B: The horizontal lines of the lattice images are broken, but no abnormalities are found in the vertical lines thereof.
C: The horizontal lines of the lattice images are broken, and the vertical lines thereof are also broken.
D: The horizontal lines of the lattice images disappear, and the vertical lines thereof are broken.
E: The horizontal lines of the lattice images disappear, and the vertical lines thereof also disappear.

At this time, the horizontal lines in the lattice images refer to lines parallel to the cylindrical axis direction of the electrophotographic photosensitive member, and the vertical lines therein refer to lines perpendicular to the cylindrical axis direction of the photosensitive member.

<Evaluation of Transferability>

A reconstructed machine of a commercially available laser beam printer “i-SENSYS LBP 673 Cdw” manufactured by Canon Inc. was used. The printer was reconstructed as follows: the main body and software of the evaluation machine were changed to enable a change in bias to be applied in a transferring step.

Toner in the cyan cartridge of the evaluation machine “i-SENSYS LBP 673 Cdw” is removed, and a required amount of the toner 1 is loaded thereinto.

The cyan toner cartridge of the evaluation machine was left to stand under a normal-temperature and normal-humidity environment (25° C., 50% RH; hereinafter also referred to as “N/N”) for 24 hours. The toner cartridge after 24 hours of the standing under the environment was mounted on the above-mentioned evaluation machine, and an image having a print percentage of 5.0% was printed out on up to 500 sheets of A4 paper under the N/N environment as follows: margins each having a width of 50 mm were arranged on the left and right sides of the paper, and the image was printed out on the central portion of the paper in its horizontal direction.

An electrophotographic photosensitive member was evaluated for its transferability by: outputting solid images at the initial stage of its use (after the printing on the first sheet) and after the printing on the 500 sheets (after its long-term use); and collecting transfer residual toner on the electrophotographic photosensitive member at the time of the formation of the solid images with a transparent tape made of transparent polyester (POLYESTER TAPE 5511, Nichiban Co., Ltd.).

The density of the transfer residual toner was measured by the following approach. The transparent tape, which had been peeled from the surface of the electrophotographic photosensitive member and had collected the transfer residual toner, and a brand-new transparent tape were each bonded onto high white paper (GF-0081, Canon Inc.). Then, the density D1 of the transparent tape in the portion from which the transfer residual toner had been collected and the density DO of the brand-new transparent tape portion were each measured with an X-Rite color reflection densitometer (manufactured by X-Rite, Inc., X-Rite 500 Series).

The difference “D1−D0” obtained by the measurement was adopted as the density of the transfer residual toner. A smaller numerical value of the transfer residual toner density means that the amount of the transfer residual toner is smaller.

The transferability was judged from the transfer residual toner density as described below. The resultant transfer residual density was ranked on 5 stages of from A to E based on the following criteria. The ranks A to D out of the ranks were each regarded as the rank at which the effect of the present invention was expressed. The evaluation results are shown in Tables 7 and 8.

The densities were measured with an X-Rite color reflection densitometer (manufactured by X-Rite, Inc., X-Rite 500 Series).

(Evaluation Criteria)

A: The transfer residual density is less than 0.04.
B: The transfer residual density is 0.04 or more and less than 0.08.
C: The transfer residual density is 0.08 or more and less than 0.13.
D: The transfer residual density is 0.13 or more and less than 0.18.
E: The transfer residual density is 0.18 or more.

TABLE 7

| | | Injection | | | Transferability | |
|---|---|---|---|---|---|---|
| | | chargeability | | | Transfer | |
| | Electrophotographic | Injection | | Initial image | residual | |
| | photosensitive | charging ratio | | smearing | density | |
| Example | member | [—] | Rank | Rank | [—] | Rank |
| Example 1 | Electrophotographic | 0.85 | B | A | 0.03 | A |
| | photosensitive | | | | | |
| | member 1 | | | | | |
| Example 2 | Electrophotographic | 0.90 | A | A | 0.01 | A |
| | photosensitive | | | | | |
| | member 2 | | | | | |
| Example 3 | Electrophotographic | 0.82 | B | A | 0.01 | A |
| | photosensitive | | | | | |
| | member 3 | | | | | |
| Example 4 | Electrophotographic | 0.84 | B | A | 0.02 | A |
| | photosensitive | | | | | |
| | member 4 | | | | | |
| Example 5 | Electrophotographic | 0.85 | B | A | 0.07 | B |
| | photosensitive | | | | | |
| | member 5 | | | | | |
| Example 6 | Electrophotographic | 0.87 | B | A | 0.03 | A |
| | photosensitive | | | | | |
| | member 6 | | | | | |
| Example 7 | Electrophotographic | 0.80 | B | A | 0.07 | B |
| | photosensitive | | | | | |
| | member 7 | | | | | |
| Example 8 | Electrophotographic | 0.92 | A | A | 0.03 | A |
| | photosensitive | | | | | |
| | member 8 | | | | | |
| Example 9 | Electrophotographic | 0.95 | A | A | 0.04 | B |
| | photosensitive | | | | | |
| | member 9 | | | | | |
| Example | Electrophotographic | 0.94 | A | A | 0.04 | B |
| 10 | photosensitive | | | | | |
| | member 10 | | | | | |
| Example | Electrophotographic | 0.93 | A | A | 0.04 | B |
| 11 | photosensitive | | | | | |
| | member 11 | | | | | |
| Example | Electrophotographic | 0.95 | A | A | 0.07 | B |
| 12 | photosensitive | | | | | |
| | member 12 | | | | | |
| Example | Electrophotographic | 0.86 | B | A | 0.07 | B |
| 13 | photosensitive | | | | | |
| | member 13 | | | | | |
| Example | Electrophotographic | 0.64 | D | D | 0.03 | A |
| 14 | photosensitive | | | | | |
| | member 14 | | | | | |
| Example | Electrophotographic | 0.61 | D | D | 0.03 | A |
| 15 | photosensitive | | | | | |
| | member 15 | | | | | |
| Example | Electrophotographic | 0.94 | A | A | 0.02 | A |
| 16 | photosensitive | | | | | |
| | member 16 | | | | | |
| Example | Electrophotographic | 0.74 | C | A | 0.01 | A |
| 17 | photosensitive | | | | | |
| | member 17 | | | | | |
| Example | Electrophotographic | 0.91 | A | A | 0.02 | A |
| 18 | photosensitive | | | | | |
| | member 18 | | | | | |
| Example | Electrophotographic | 0.94 | A | A | 0.02 | A |
| 19 | photosensitive | | | | | |
| | member 19 | | | | | |
| Example | Electrophotographic | 0.97 | A | A | 0.05 | B |
| 20 | photosensitive | | | | | |
| | member 20 | | | | | |
| Example | Electrophotographic | 0.98 | A | A | 0.06 | B |
| 21 | photosensitive | | | | | |
| | member 21 | | | | | |
| Example | Electrophotographic | 0.94 | A | A | 0.07 | B |
| 22 | photosensitive | | | | | |
| | member 22 | | | | | |
| Example | Electrophotographic | 0.70 | C | A | 0.17 | D |
| 23 | photosensitive | | | | | |
| | member 23 | | | | | |
| Example | Electrophotographic | 0.71 | C | B | 0.14 | D |
| 24 | photosensitive | | | | | |
| | member 24 | | | | | |
| Example | Electrophotographic | 0.85 | B | D | 0.02 | A |
| 25 | photosensitive | | | | | |
| | member 25 | | | | | |
| Example | Electrophotographic | 0.91 | A | A | 0.01 | A |
| 26 | photosensitive | | | | | |
| | member 26 | | | | | |
| Example | Electrophotographic | 0.91 | A | C | 0.03 | A |
| 27 | photosensitive | | | | | |
| | member 27 | | | | | |
| Example | Electrophotographic | 0.72 | C | A | 0.02 | A |
| 28 | photosensitive | | | | | |
| | member 28 | | | | | |
| Example | Electrophotographic | 0.77 | C | D | 0.04 | B |
| 29 | photosensitive | | | | | |
| | member 29 | | | | | |
| Example | Electrophotographic | 0.70 | C | D | 0.03 | A |
| 30 | photosensitive | | | | | |
| | member 30 | | | | | |
| Example | Electrophotographic | 0.92 | A | A | 0.13 | D |
| 31 | photosensitive | | | | | |
| | member 31 | | | | | |
| Example | Electrophotographic | 0.92 | A | C | 0.02 | A |
| 32 | photosensitive | | | | | |
| | member 32 | | | | | |
| Example | Electrophotographic | 0.90 | A | A | 0.13 | C |
| 33 | photosensitive | | | | | |
| | member 33 | | | | | |
| Example | Electrophotographic | 0.77 | C | D | 0.17 | D |
| 34 | photosensitive | | | | | |
| | member 34 | | | | | |
| Example | Electrophotographic | 0.90 | A | A | 0.13 | C |
| 35 | photosensitive | | | | | |
| | member 35 | | | | | |
| Example | Electrophotographic | 0.65 | D | D | 0.07 | B |
| 36 | photosensitive | | | | | |
| | member 36 | | | | | |
| Example | Electrophotographic | 0.87 | B | A | 0.13 | C |
| 37 | photosensitive | | | | | |
| | member 37 | | | | | |
| Example | Electrophotographic | 0.90 | A | A | 0.17 | D |
| 38 | photosensitive | | | | | |
| | member 38 | | | | | |
| Example | Electrophotographic | 0.74 | C | C | 0.07 | B |
| 39 | photosensitive | | | | | |
| | member 39 | | | | | |
| Example | Electrophotographic | 0.69 | D | C | 0.07 | B |
| 40 | photosensitive | | | | | |
| | member 40 | | | | | |
| Example | Electrophotographic | 0.90 | A | C | 0.02 | A |
| 41 | photosensitive | | | | | |
| | member 41 | | | | | |
| Example | Electrophotographic | 0.79 | C | A | 0.03 | A |
| 42 | photosensitive | | | | | |
| | member 42 | | | | | |

TABLE 8

| | | Injection | | | | |
|---|---|---|---|---|---|---|
| | | chargeability | | | Transferability | |
| | | Injection | | | Transfer | |
| | Electrophotographic | charging | | Initial image | residual | |
| Comparative | photosensitive | ratio | | smearing | density | |
| Example | member | [—] | Rank | Rank | [—] | Rank |
| Comparative | Electrophotographic | 0.90 | A | B | 0.18 | E |
| Example 1 | photosensitive | | | | | |
| | member 43 | | | | | |
| Comparative | Electrophotographic | 0.95 | A | E | 0.19 | E |
| Example 2 | photosensitive | | | | | |
| | member 44 | | | | | |
| Comparative | Electrophotographic | 0.15 | E | A | 0.18 | E |
| Example 3 | photosensitive | | | | | |
| | member 45 | | | | | |
| Comparative | Electrophotographic | 0.46 | E | A | 0.18 | E |
| Example 4 | photosensitive | | | | | |
| | member 46 | | | | | |
| Comparative | Electrophotographic | 0.35 | E | A | 0.18 | E |
| Example 5 | photosensitive | | | | | |
| | member 47 | | | | | |
| Comparative | Electrophotographic | 0.92 | A | E | 0.07 | B |
| Example 6 | photosensitive | | | | | |
| | member 48 | | | | | |
| Comparative | Electrophotographic | 0.48 | E | A | 0.32 | E |
| Example 7 | photosensitive | | | | | |
| | member 49 | | | | | |
| Comparative | Electrophotographic | 0.42 | E | E | 0.12 | C |
| Example 8 | photosensitive | | | | | |
| | member 50 | | | | | |
| Comparative | Electrophotographic | 0.31 | E | A | 0.03 | A |
| Example 9 | photosensitive | | | | | |
| | member 51 | | | | | |
| Comparative | Electrophotographic | 0.95 | A | E | 0.17 | D |
| Example 10 | photosensitive | | | | | |
| | member 52 | | | | | |
| Comparative | Electrophotographic | 0.37 | E | A | 0.02 | A |
| Example 11 | photosensitive | | | | | |
| | member 53 | | | | | |
| Comparative | Electrophotographic | 0.97 | A | E | 0.07 | B |
| Example 12 | photosensitive | | | | | |
| | member 54 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2022-107921, filed Jul. 4, 2022, No. 2023-036758, filed Mar. 9, 2023 and No. 2023-072660, filed Apr. 26, 2023, which are hereby incorporated by reference herein in their entirety.

What is claimed is:

1. An electrophotographic photosensitive member comprising a surface layer containing a binder resin, electroconductive particles, and insulating particles,
wherein when a volume resistivity of the insulating particles is represented by R1 [Ω·cm], a volume resistivity of the electroconductive particles is represented by R2 [Ω·cm], a ratio of an area of the insulating particles that are exposed to a total area of the surface layer is represented by S1 [%], a ratio of an area of the electroconductive particles that are exposed to the total area of the surface layer is represented by S2 [%], an average exposed height of the insulating particles exposed to a surface of the electrophotographic photosensitive member is represented by L1 [nm], and an average exposed height of the electroconductive particles exposed to the surface of the electrophotographic photosensitive member is represented by L2 [nm], the R1, the R2, the S1, the S2, the L1, and the L2 satisfy the following formulae (1) to (7):
10¹⁰≤R1 (1)
R2≤10⁸ (2)
5≤S1≤75 (3)
25≤S1+S2≤95 (4)
0.13≤S1/S2≤3.8 (5)
30≤L1≤180 (6)
1.2≤L1/L2≤2.8 (7).

2. The electrophotographic photosensitive member according to claim 1, wherein the R1 satisfies the following formula (8):
10¹³≤R1 (8).

3. The electrophotographic photosensitive member according to claim 1, wherein when an average primary particle diameter of the insulating particles is represented by D1 [nm], and an average primary particle diameter of the electroconductive particles is represented by D2 [nm], the D1 and the D2 satisfy the following formula (9):
1.2≤D1/D2 (9).

4. The electrophotographic photosensitive member according to claim 1, wherein when an average primary particle diameter of the insulating particles is represented by D1 [nm], and an average primary particle diameter of the electroconductive particles is represented by D2 [nm], the D1 and the D2 satisfy the following formula (10):
D1/D2≤2.8 (10).

5. The electrophotographic photosensitive member according to claim 1, wherein when an average primary particle diameter of the insulating particles is represented by D1 [nm], the D1 satisfies the following formula (11):
60≤D1≤180 (11).

6. The electrophotographic photosensitive member according to claim 1, wherein when an average primary particle diameter of the electroconductive particles is represented by D2 [nm], the D2 satisfies the following formula (12):
D2≤70 (12).

7. The electrophotographic photosensitive member according to claim 1, wherein a total sum of volumes of the electroconductive particles and the insulating particles to be incorporated into the surface layer accounts for 40% or more of a total volume of the surface layer.

8. The electrophotographic photosensitive member according to claim 1,
wherein the electroconductive particles are niobium-doped titanium oxide particles, and
wherein, in EDS analysis of each of the niobium-doped titanium oxide particles with a scanning transmission electron microscope (STEM), a concentration ratio calculated as a ratio “niobium atom concentration/titanium atom concentration” at an inside portion at 5% of a primary particle diameter of the niobium-doped titanium oxide particle from a surface of the niobium-doped titanium oxide particle is 2.0 or more times as high as a concentration ratio calculated as a ratio “niobium atom concentration/titanium atom concentration” at a central portion of the niobium-doped titanium oxide particle.

9. The electrophotographic photosensitive member according to claim 1, wherein the insulating particles have an average circularity of 0.95 or more and 1.0 or less.

10. A process cartridge comprising:
an electrophotographic photosensitive member; and
at least one unit selected from the group consisting of: a charging unit; a developing unit; and a cleaning unit,
the process cartridge integrally supporting the electrophotographic photosensitive member and the at least one unit, and being detachably attachable onto a main body of an electrophotographic apparatus,
the electrophotographic photosensitive member including a surface layer containing a binder resin, electroconductive particles, and insulating particles,
wherein when a volume resistivity of the insulating particles is represented by R1 [Ω·cm], a volume resistivity of the electroconductive particles is represented by R2 [Ω·cm], a ratio of an area of the insulating particles that are exposed to a total area of the surface layer is represented by S1 [%], a ratio of an area of the electroconductive particles that are exposed to the total area of the surface layer is represented by S2 [%], an average exposed height of the insulating particles exposed to a surface of the electrophotographic photosensitive member is represented by L1 [nm], and an average exposed height of the electroconductive particles exposed to the surface of the electrophotographic photosensitive member is represented by L2 [nm], the R1, the R2, the S1, the S2, the L1, and the L2 satisfy the following formulae (1) to (7):
10¹⁰≤R1 (1)
R2≤10⁸ (2)
5≤S1≤75 (3)
25≤S1+S2≤95 (4)
0.13≤S1/S2≤3.8 (5)
30≤L1≤180 (6)
1.2≤L1/L2≤2.8 (7).

11. An electrophotographic apparatus comprising:
an electrophotographic photosensitive member; and
a charging unit, an exposing unit, a developing unit, and a transfer unit,
the electrophotographic photosensitive member including a surface layer containing a binder resin, electroconductive particles, and insulating particles,
wherein when a volume resistivity of the insulating particles is represented by R1 [Ω·cm], a volume resistivity of the electroconductive particles is represented by R2 [Ω·cm], a ratio of an area of the insulating particles that are exposed to a total area of the surface layer is represented by S1 [%], a ratio of an area of the electroconductive particles that are exposed to the total area of the surface layer is represented by S2 [%], an average exposed height of the insulating particles exposed to a surface of the electrophotographic photosensitive member is represented by L1 [nm], and an average exposed height of the electroconductive particles exposed to the surface of the electrophotographic photosensitive member is represented by L2 [nm], the R1, the R2, the S1, the S2, the L1, and the L2 satisfy the following formulae (1) to (7):
10¹⁰≤R1 (1)
R2≤10⁸ (2)
5≤S1≤75 (3)
25≤S1+S2≤95 (4)
0.13≤S1/S2≤3.8 (5)
30≤L1≤180 (6)
1.2≤L1/L2≤2.8 (7).
